(19) United States
(12) Patent Application Publication
(10) Pub. No.: US 2025/0200792 A1
(43) Pub. Date: Jun. 19, 2025

(54) COLOR PATTERNED SPHERICAL MARKERS (CPSM), METHODS FOR DETECTING AND RECOGNIZING CPSMS BASED ON ARTIFICIAL INTELLIGENCE, METHODS FOR USING CPSMS FOR 6 DEGREE OF FREEDOM POSITIONING AND RELATED SYSTEMS

(71) Applicant: Tibor DEAK, Budapest (HU)

(72) Inventor: Tibor DEAK, Budapest (HU)

(73) Assignee: Tibor DEAK, Budapest (HU)

(21) Appl. No.: 18/939,660

(22) Filed: Nov. 7, 2024

Related U.S. Application Data
(60) Provisional application No. 63/547,851, filed on Nov. 9, 2023.

(51) Int. Cl. G06T 7/73; G06T 15/00

(52) U.S. Cl. CPC G06T 7/73; G06T 15/00; G06T 2207/10024; G06T 2207/20081; G06T 2207/20084; G06T 2207/30204; G06T 2207/30244

(57) ABSTRACT

The present invention proposes new type of spherical fiducial markers (CPSMs) which are characterized by colored pattern elements printed on a spherical surface, a method for forming CPSMs, a method for forming a system by spatial arrangement of plurality of CPSMs—called CPSM sets, a learning based method for detecting and recognizing CPSMs from a long range with an image sensing device, a method for using detection and recognition results for 6 degree of freedom pose estimation. The colored pattern elements are designed and arranged on the surface of a CPSM so that the image plane view of the CPSM from an arbitrary direction is distinctive to infer the CPSM's identifier and its pose metrics with essentially viewpoint-independent accuracy. CPSM sets enable high accuracy pose estimation, extended ID encodings and accelerated scene calibration.

### TECHNICAL FIELD

The present disclosure generally relates to the technical field of visual markers and use of visual markers in augmented reality and robotics applications.

### BACKGROUND

Visual fiducial markers (markers) are widely used in augmented reality and robotics applications to identify and localize objects that can be detected by an image sensing device (furthermore referred to as camera). These markers are either used as fixed points of reference in a scene from which the temporally changing 3D location and 3D orientation of the camera relative to marker(s)—called camera pose—is estimated or the camera is fixed and the marker(s)' temporally changing 3D location and 3D orientation relative to the camera—called marker pose—is estimated. Encoding IDs to marker designs serves dual purpose: (i) make the marker or plurality of markers uniquely identifiable (MUI), (ii) enabling non-ambiguous establishment of 2D-3D point correspondences (EPC) for pose estimation. EPC is a pre-requisite to execute many pose estimation algorithms (see PnP methods). The range of marker IDs to satisfy MUI is usually much larger than the range to satisfy EPC. For example, to solve a four-point PnP problem with the help of four visible spherical markers, non-ambiguous EPC is satisfied by four uniquely identified markers, i.e. the range of required marker IDs is {1 . . . 4}, see an example in [6]. However, simultaneously visible four markers on a first scene with ID range of {1 . . . 4} may not be distinguishable from a second scene where four markers with the same ID range of {1 . . . 4} are visible. As an example, to satisfy MUI with a capacity for 27,405 differentiable sets of four markers as well as to satisfy non-ambiguity of EPC, a marker ID range of {1 . . . 30} needs to be designed (27,405 equals the number of combinations of 30 items taken 4 at a time). While to satisfy MUI alternative, non-visual identification methods may be used, for example radio beacons, EPCs rely on visual information content.

Recognition of marker IDs and pose estimation is based on extraction and localization of visual features on the image plane supplemented with calculations that use a-priori information, like the marker(s)' type/ID range/world size and/or results from previous pose estimations and/or simultaneous pose estimation of another camera. The steps of ID recognition(s) and pose estimation from the image with visible fiducial marker(s) are (i) detection of marker(s), (ii) ID prediction (recognition) of marker(s), (iii) pose estimation. The said extracted visual features can be of various type and depend on the design of the marker, the design of the underlying algorithms and the noise artifacts (illumination variances, focus/motion blur, surface deformations, camera distortion, etc.) that are accounted for in the said steps. Apart from the design of the marker and the underlying algorithms the main factors impacting the accuracy of detection/ID prediction/pose estimation steps are (i) the size of the marker(s), (ii) the distance of marker(s) from camera (iii) camera resolution, (iv) angle-of-view, (v) noise artifacts. It is well known to those skilled in the art—given a (i) marker design, (ii) a marker recognition algorithmic design, (iii) size of the marker(s), (iv) distance of marker(s) from camera, (v) camera resolution, (vi) angle-of-view—that by increasing the markers' range of IDs the recognition accuracy decreases. This is explained by the fact that to classify a marker with a wider range of possible IDs and to keep the same classification error percentage more image details are required, i.e., the camera and the marker need to move closer. State-of-the-art fiducial marker designs and/or systems built upon a plurality of markers are missing a concept of two-tier marker ID encodings, in other words, a mechanism of having primary and secondary IDs, the primary IDs being recognizable at significantly larger camera-marker distances then the secondary IDs.

Visual fiducial markers are typically designed to be printed on a planar surface and reside on a planar or a cylindrical surface. Consequently, recognition accuracy of planar-printed markers is sensitive to angle-of-view. Acceptable accuracy values can be expected typically within a {−70+70} degrees angle-of-view range which corresponds to only 15% volume of the 3D space defined by the entire angle-of-view range of 360 degrees.

To overcome the angle-of-view problem characterizing all 2D visual markers multiple 2D markers are arranged on a 3D surface like cube, octagon, see for example a solution in U.S. patent [1]. The pose estimate derived from the resulting 3D surface relies on the piece-by-piece detection, ID recognition and pose estimate of the underlying 2D markers, making it computationally less efficient and requiring that image crops—the detected markers with a bounding box—reach a typical size of 100×100 pixels for all 2D markers.

Spherical fiducial markers and pose estimation algorithms based on spherical fiducial markers are known the by state-of-the-art and have use cases in medical surgery and robotics fields, see for example a solution in U.S. patent [2]. However, the color texture of these spherical fiducial markers is homogenous and therefore (i) are not suitable for pose estimation using a single piece of marker, (ii) are not suitable for large MUI capacity.

Learning based non-planar fiducial marker pattern generation techniques exist that are designed to treat the pattern generation, detection/ID prediction/pose estimation steps in an end-to-end manner. These techniques can also be applied to create colored patterns on spherical surfaces, as disclosed in U.S. patent publication [4]. However, the resulting patterns are missing sharp contrasts and use a large color palette. Physically printing these patterns on a spherical surface carries a technological challenge and is either expensive or compromises the computer-optimized fine and color-rich texture. To calculate said computer-optimized textures is expensive and re-calculation is necessary for each marker ID.

Learning based models and methods are used in the disclosure for the hand-crafted CPSMs' detection, ID prediction steps and several stages of the pose estimation step. Although these learning-based models and methods are known by the state-of-the art, some subprocesses are novel and capitalize on the texture of CPSMs. For example, well-known learning-based object detectors, like SSD, Yolo that may be used in the disclosure for CPSMs' coarse detection are supplemented with morphological operations that deliver more accurate coordinates of the detection bounding box. Said well-known object detectors also teach to perform object detection and object classification simultaneously, utilizing the same visual features extracted from the image for both detection and classification. However, the disclosure is using said well-known object detectors with a single object category, performing object classification after object detection by another learning-based model that analyses the color spectrum of the detected object. This approach has the advantage of a much leaner training process for object detection and a more robust ID prediction from larger CPSM-camera distances. The detection distance of CPSMs enabled by the system disclosed in the present invention exceeds that of marker designs planned for detections from long distance, for example the solution in U.S. patent [3]. Robust ID prediction by analyzing said color spectrum becomes possible due to careful design of CPSMs' color scheme, which secures that said color spectrum is simultaneously ID distinctive and essentially viewpoint independent.

The proposed system built upon plurality of CPSMs (CPSM sets) is highly scalable and enables secondary ID encodings by purely rotating set-member CPSMs that may be attached to a rigid frame. As an example, a set formed by four CPSMs with ID range of {1 . . . 30} provides a primary MUI capacity of 27,405 based on CPSM IDs, with satisfied non-ambiguous EPC. As outlined by the disclosure—in a preferred embodiment—the secondary ID capacity of a set with n number of CPSMs is 24^{\hat{ }n}. Thus, utilizing the secondary ID capacity of a set with four CPSMs the combined MUI capacity is 27,405*331,776˜=9.1*10^{\hat{ }9}. In a preferred embodiment, secondary IDs can be used to recover set identification when not all CPSM IDs of the set are known because of occlusions or camera field-of-view limitations. In the previous example, a set of four CPSMs with ID range of {1 . . . 30} and forming a regular tetrahedron, the same MUI capacity of 27,405 can be achieved by a-priori hash-unique calibration, i.e. by combining any pair of CPSM IDs and the relative orientation of these two CMPSs in a set to represent unique hash indices. Using the hash indices only two set members' detection is necessary to infer the set's MUI and pose. The disclosure presents a process for said hash-unique calibration, which technique can also be used for CPSM ID recognition error corrections.

The disclosure also embeds a process of how independent pose estimations based on detected CPSMs and optionally available pose estimations based on PnP problem solutions are fused. Fusion of independent pose estimations is often referred to as pose graph optimizations. Pose graph optimizations assume that uncertainty metrics of measurements are available. The disclosure introduces a learning-based noise estimator that uses the color spectrum of detected CPSMs to predict uncertainty metrics that may be used in pose graph optimizations.

To compare CPSM sets' pose estimation performance with state-of-the-art visual fiducial marker solutions a metric of image plain occupancy rate is introduced. Occupancy rate is the ratio of pixels occupied by visual fiducial marker(s) relative to the total number of pixels on the image plane. Thus, it is possible to compare the end-to-end pose estimation performance of e.g., a CPSM set with 4 small spheres with a large-sized single planar fiducial marker. Occupancy rate has a relevance in augmented reality applications where high-occupancy-rate solutions may block too much of “reality” details present on the image plane. Assuming the same average pose estimation accuracy, CPSM sets' occupancy rate is typically 30% or less than that of alternative pose estimation solutions of state-of-the-art.

Spherical shapes are one of the most widespread 3D shapes in our everyday environment. Mass production light bulbs are manufactured in various sizes. By using light-emitting spherical surfaces many noise artifacts—like motion blur or specular reflection—could be reduced relative to those surfaces being passive in light emission. Printing partially translucent patterns on spherical surfaces with limited range of colors is a well-known technique, see an example in [7]. Custom made (designer) spherical patterns can be printed on planar vinyl sheets and applied on spherical surfaces by taking advantage of extensibility of vinyl.

Hand-crafted CPSMs, the related systems and methods disclosed in the present invention simultaneously (i) eliminate the angle-of-view range limitation, (ii) provide a novel and robust concept for two-tier ID encodings, (iii) introduces a novel hash indexing technique to handle CPSM occlusion scenarios, and (iv) significantly decrease the image plane occupancy rate.

### SUMMARY OF THE DISCLOSURE

The first objective of the present invention is to describe a system and method for creation a series of CPSMs that are simultaneously distinguishable from one another and satisfy one-by-one the criterium of having distinctive image plane footprints from any 3D viewpoint.

A second objective of the present invention is to solve the technical problem of how CPSMs are detected from reasonably large distances.

A third objective of the present invention is to disclose how detected CPSMs are recognized and how image capturing noise is estimated. In a preferred embodiment, recognition means decoding the CPSM's ID embedded in its color scheme.

A fourth objective of the present invention is to disclose how the 6 degree of freedom (6 DoF) pose is calculated from a single CPSM detected on an image.

A fifth objective of the present invention is to propose spatial arrangements of plurality of CPSMs to form CPSM sets. Using CPSM sets the calculated pose accuracy can be improved by solving a multiple node pose graph optimization problem that use (i) the a-priori known geometric constraints of CPSM set(s) and camera(s), (ii) the multiple CPSM pose measurements on a single image plane and the optionally available Perspective-n-Point (PnP) problem solutions where CPSM centers act as point correspondences, (iii) the multiple images captured of the scene by one or more camera(s).

A sixth objective of the present invention is to disclose how to calibrate CPSM sets so that the relative orientation of CPSMs forming a set can be used to provide secondary ID encoding capacity in addition to primary ID capacity provided by CPSMs.

### BRIEF DESCRIPTION OF THE DRAWINGS

FIG. 1 is the block diagram of a CPSM based 6 DoF positioning system.

FIG. 2 shows the inner structure of CPSM parameter stores, an element of the CPSM based 6 DoF positioning system.

FIG. 3 shows elements of the terminology used in the definition of spherical grids.

FIG. 4 is the flow chart of the CPSM designer process.

FIG. 5 shows the data structure of a preferred embodiment parameter set store.

FIG. 6 is the flow chart of a process for definition of cell polarity matrices.

FIG. 7 shows an example seed pattern array store.

FIG. 8 shows how modulated pattern matrices are generated from a seed pattern array by sequentially applying two subprocesses.

FIG. 9 shows examples of cell polarity matrices with dimension 31×31, indicating the pattern generation method and the source seed pattern arrays, when applicable.

FIG. 10 is a flow chart of a subprocess for modulation of a non-modulated spherical grid.

FIG. 11 shows example outputs of θ-azimuthal-angle-modulation-related steps of the subprocess for modulation of a non-modulated spherical grid.

FIG. 12 shows example outputs of φ-elevation-angle-modulation-related steps of the subprocess for modulation of a non-modulated spherical grid.

FIG. 13 shows examples of spherical grid modulations, with and without azimuthal/elevation angles θ/φ modulations.

FIG. 14 is a flow chart of a process for definition of cell color schemes.

FIG. 15 shows a preferred embodiment preferred embodiment cell color scheme store.

FIG. 16 shows a table exhibiting the combinations of various color modulation frequency and color set size scenarios.

FIG. 17 shows example outputs of subprocesses of the process of definition of cell color schemes.

FIG. 18 shows two examples for color modulation and color assignment related subprocesses of the process for definition of cell color schemes.

FIG. 19 show views of bicolor CPSMs, originated from Hadamard cell polarity matrices and seed pattern arrays, to visualize the effects of transferring cell polarity matrices to spherical grids.

FIG. 20 shows views of bicolor CPSMs, originated from Hadamard cell polarity matrix.

FIG. 21 shows the views of a bicolor CPSM, originated from Hadamard cell polarity matrix, with non-modulated spherical grid scheme.

FIG. 22 is a flow chart of a view renderer process that generates synthetic view images from plurality of virtual camera positions.

FIG. 23 is a flow chart of a process for augmentation of synthetic view images.

FIG. 24 shows images illustrating the effects of various augmentation steps.

FIG. 25 shows examples of CPSM tessellation sheets.

FIG. 26 is a flow chart of a process for training a standard object detector.

FIG. 27 shows a background image and a training image of a standard object detector.

FIG. 28 is a flow chart of a process for detection of CPSMs.

FIG. 29 shows examples of cascade images and a pyramid image, used in the CPSM detection process.

FIG. 30 shows examples of extended bounding boxes, used in the CPSM detection process.

FIG. 31 shows examples of refined square-shaped bounding boxes, used in the CPSM detection process.

FIG. 32 is a flow chart of a process for training a CPSM recognizer.

FIG. 33 shows two circle masks, used in the CPSM recognizer training process.

FIG. 34 is a flow chart of a process for training a CPSM orientation predictor.

FIG. 35 exhibits input image examples for various versions of CPSM orientation predictor.

FIG. 36 shows preferred embodiments of CNN model versions, used in a CPSM orientation predictor.

FIG. 37 shows image plane projections of spheres, used in a process for training a CPSM distance predictor.

FIG. 38 is a flow chart of a process for training a CPSM distance predictor.

FIG. 39 is a flow chart of a process for a CPSM set tracking controller.

FIG. 40 is a flow chart of a subprocess for defining CPSM set models and CPSM set model stores.

FIG. 41 is a flow chart of a subprocess for defining work-in-progress CPSM sets.

FIG. 42 is a flow chart of a subprocess for calibrating work-in-progress CPSM sets.

FIGS. 43A through 43C show examples of CPSM set model stores.

FIG. 44 shows six preferred embodiment CPSM set model types.

FIG. 45 shows an example CPSM set calibration store and the associated hash matrix.

FIG. 46 shows example reference coordinate systems used in a subprocess for calibration of work-in-progress CPSM sets.

FIG. 47 is a flow chart of a subprocess for assigning detections to key points of calibrated CPSM sets.

FIG. 48 shows an example recognition probability matrix and a detection-recognition-assignment matrix.

FIG. 49 shows a spatial arrangement of two CPSMs which helps to follow the steps of hash index calculations.

FIGS. 50A and 50B show a CPSM and a series of coordinate systems which help to follow the steps of calculating the camera pose.

### SYSTEM OVERVIEW

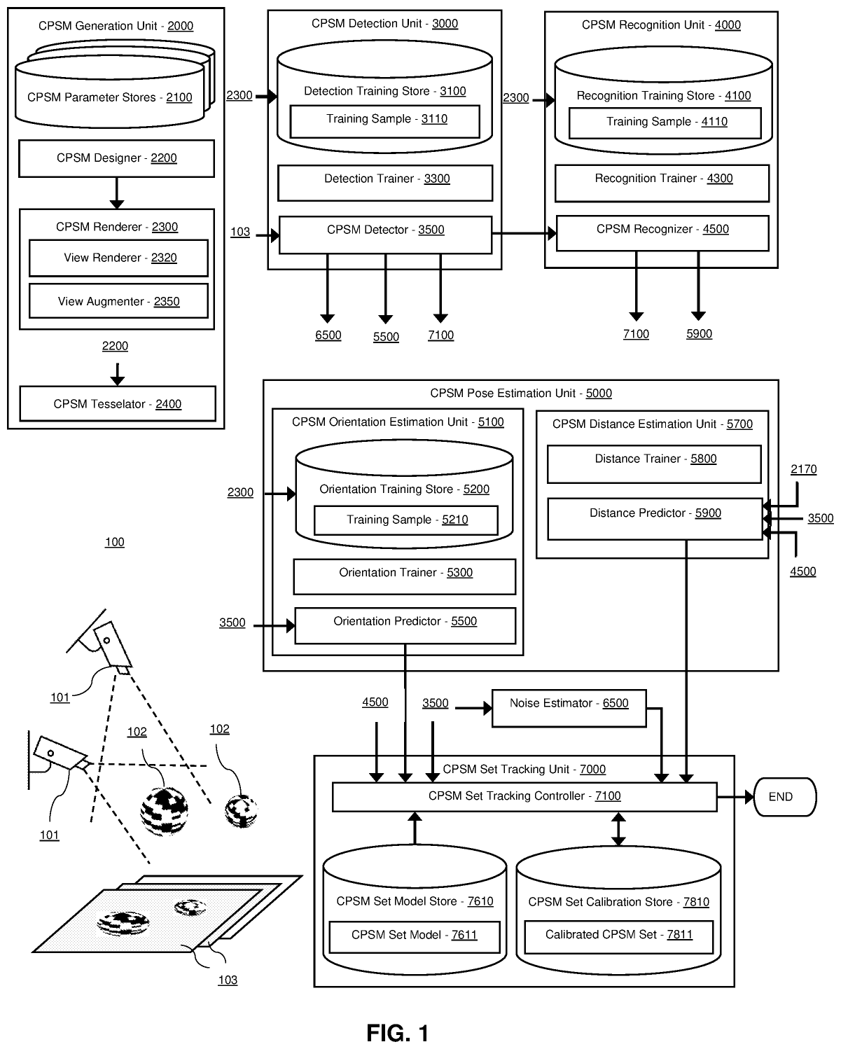

FIG. 1 is the block diagram of a CPSM based 6 DoF positioning system 100, in accordance with some embodiments. The system 100 comprises plurality of CPSMs 102 on a scene, one or more camera(s) 101, a CPSM generation unit 2000, a CPSM detection unit 3000, a CPSM recognition unit 4000, a CPSM pose estimation unit 5000 and a CPSM set tracking unit 7000.

Camera(s) 101 captures observation images 103 and forwards them to CPSM detector 3500.

The offline CPSM generation unit 2000 comprises a CPSM parameter store 2100, a CPSM designer 2200, a CPSM renderer 2300 and a CPSM tesselator 2400. CPSM designer 2200 generates plurality CPSM designs that are simultaneously distinguishable from one another and have distinctive image plane footprints from any 3D viewpoint. The results of the CPSM design process are stored in CPSM parameter store 2100. CPSM renderer 2300 generates photorealistic synthetic training images from plurality of 3D viewpoints for each instance of CPSM design and forwards these training images together with metadata comprising (i) the CMPS ID 2172, (ii) the coordinates of 3D viewpoints and (iii) the applied image augmentation parameters to detection training store 3100, recognition training store 4100 and orientation training store 5200. CPSM tesselator 2400 generates two-dimensional tessellation sheets 2401 for each CPSM design instance.

CPSM detection unit 3000 comprises a detection training store 3100, a detection trainer 3300 and a CPSM detector 3500. Detection training store 3100 stores training samples 3110 used by the detection trainer 3300 to train the learning based CPSM detector 3500. The trained CPSM detector 3500 extracts regions of interests by providing detection bounding box coordinates of all CPSMs 102 detected on observation images 103 captured by camera(s) 101.

CPSM recognition unit 4000 comprises a recognition training store 4100, a recognition trainer 4300 and a CPSM recognizer 4500. Recognition training store 4100 stores training samples 4110 used by the recognition trainer 4300 to train the learning based CPMS recognizer 4500 and noise estimator 6500. The trained CPMS recognizer 4500 provides the classification—the primary ID prediction—of a CPSM 102 present on a detection image crop. The detection image crops are created by cropping images from observation images 103 by said detection bounding box coordinates.

CPSM pose estimation unit 5000 comprises a CPSM orientation estimation unit 5100 and a CPSM distance estimation unit 5700. CPSM orientation estimation unit 5100 comprises an orientation training store 5200, an orientation trainer 5300 and an orientation predictor 5500. Orientation training store 5200 stores training samples 5210 used by the orientation trainer 5300 to train the learning-based orientation predictor 5500. The trained orientation predictor 5500 provides polar and roll rotation angle predictions of a CPSM 102 present on a said detection input image crop. CPSM distance estimation unit 5700 comprises a distance trainer 5800 and a learning-based distance predictor 5900. Distance trainer 5800 is training the distance predictor 5900, using synthetic training samples and the a-priori available intrinsic calibration parameters of camera(s) 101 capturing observation images 103. The trained distance predictor 5900 estimates the distance of a detected CPSM 102 from camera(s) 101 by using said detection bounding box coordinates and the physical size—world radius 2173—of the CPSM 102, retrieved from parameter set store 2170.

The trained noise estimator 6500 provides noise score estimation of said detection image crops.

CPSM set tracking unit 7000 comprises a CPSM set tracking controller 7100, a CPSM set model store 7610 and a CPSM set calibration store 7810. CPSM set tracking controller 7100 (i) fuses the output results of CPSM detector 3500, CPSM recognizer 4500, orientation predictor 5500, distance predictor 5900 and noise estimator 6500, (ii) retrieves data from CPSM set model store 7610 and CPSM set calibration store 7810 to calculate the 6 DoF pose of camera(s) 101 in the intrinsic coordinate systems 5833 of CPSM(s) 102 and/or the intrinsic coordinate systems 7622 of CPSM sets and/or world coordinate system, (iii) optionally updates the world pose 7814 data field of CPSM set calibration store 7810. CPSM set model store 7610 stores the parameters of valid CPSM set models 7611 and acts as a verification filter. A CPSM set model 7611 is storing (i) the geometric coordinates 7614 of plurality of key point 7613 positions, (ii) plurality of CPSM IDs 2172 that define which CPSMs 102 can be members of that set model 7611 and to which Hash Group (HG) 7618 CPSM IDs 2172 belong to. CPSM set models 7611 in a CPSM set model store 7610 are temporally stable and defined a-priori. CPSM set calibration store 7810 stores hash matrix 7815 and calibration parameters in calibrated CPSM sets 7811 for all valid CPSM sets and acts as a verification filter. The data in a CPSM set model 7611, hash matrix 7815 and a calibrated CPSM set 7811 record enables the CPSM set tracking controller 7100 to associate fully or partially detected CPSM sets with calibrated CPSM sets 7811 and—optionally—determine their world pose 7814. Inferred world poses 7814 may be back written to calibrated CPSM set 7811 records to act further as landmarks.

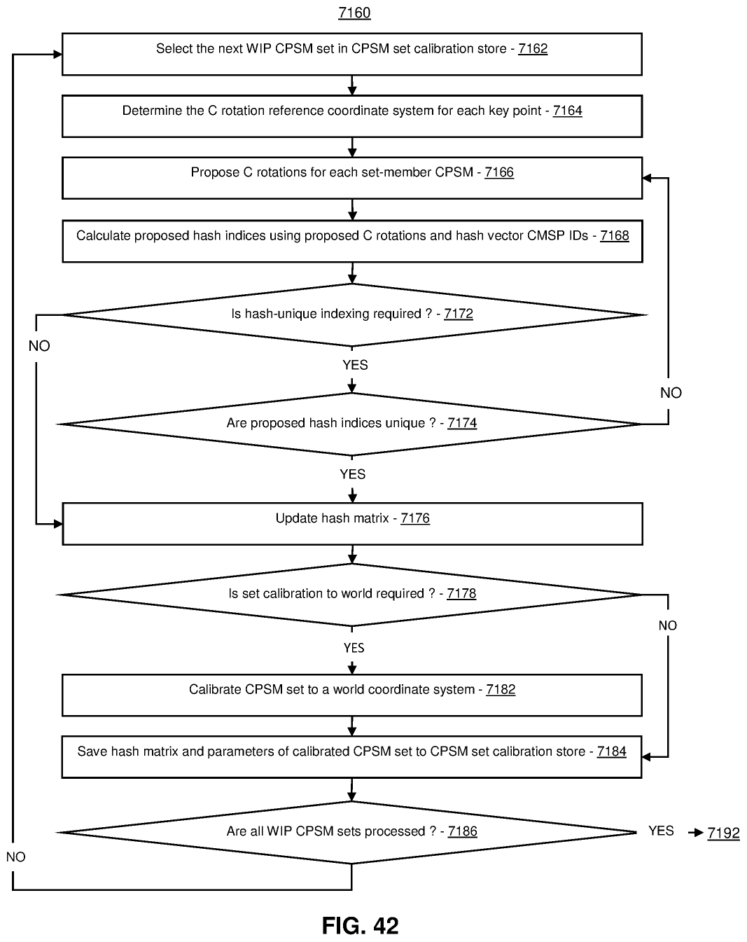

The CPSM set ID prediction and 6 DoF pose estimation output of CPSM set tracking controller 7100 may be further processed by other applications. The detailed description of these applications is beyond the scope of the present disclosure. In one embodiment, system 100 is used for 6 DoF indoor positioning. For example, using five different CPSM design types defined by parameter set 2171 and two CPSMs 102 in a set of type 7521B, the coding of 5,760 different set IDs becomes possible. In another example, using three different CPSM design types defined by parameter set 2171 and three CPSMs 102 in a set of type 7621C—as also exhibited in FIG. 42—the coding of 13,824 different set IDs without hash-unique calibration and 576 different set IDs with hash-unique calibration becomes possible. Using these pairs 7521B or trios 7621C of CPMSs 102 as chandeliers in premises, both premise IDs and 6 DoF positioning is encoded in the chandeliers' visual features, interpreted in the context of a selected CPSM set model store 7610, thus making the chandeliers suitable to cover large 3D spaces for e.g., location-based services. For reference to plan space coverage, a CPMS 102 with CPSM world radius 2173 of 10 cm is detected and recognized by an 8-megapixel camera 101 from 20 meters.

### DETAILED DESCRIPTION OF THE INVENTION

To discuss CPSM generation unit 2000 in detail let's introduce the terminology, in accordance with FIG. 3. A CPSM 102 is initially split by non-modulated spherical grid 2001. Non-modulated spherical grid 2001 is formed by N pieces of longitudinal spherical lines 2002 and M pieces of latitudinal spherical lines 2003. Spherical triangles 2004 and spherical quadrilaterals 2005 are confined by longitudinal spherical lines 2002 and latitudinal spherical lines 2003. Spherical triangles 2004 and spherical quadrilaterals 2005 are jointly called cells 2006. The total number of cells 2006 on the spherical surface of a CPSM 102 is N*M. Assuming that the radius of a CPSM 102 equals 1, corner coordinates of all cells 2006 are defined by two parameters in a spherical coordinate system, azimuthal angle θ_{1 . . . N} (theta) 2007 and elevation angle φ_{1 . . . M} (phi) 2008, where 0≤θ≤2*π and 0≤φ≤π. A particular constraint characteristic to a non-modulated spherical grid 2001 is that the areas of all cells 2006 are identical and equal to 4*2*π/N/M. Cell Polarity Matrix (CPM) is a matrix of size N*M containing binary values of 0 and 1 which represent the polarity of cells 2006. Polarity of cells 2006 controls whether dark (polarity 1) or light (polarity 0) colors are used when cells 2006 are colorized on the spherical surface. As a CPM is the key contributor to secure the viewpoint distinctiveness of a CPSM 102, not all CPM variants are suitable for application in CPSM designs. For example, a chessboard pattern is not suitable. Cells 2006 with polarity 1 are referred to as dark cells, cells with polarity 0 are referred to as light cells.

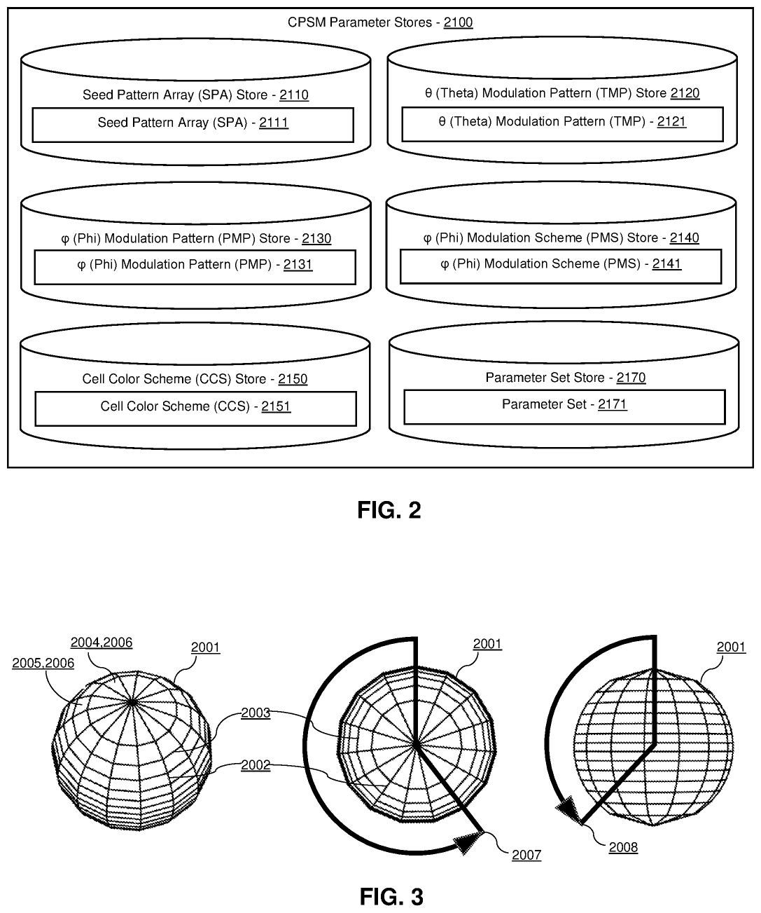

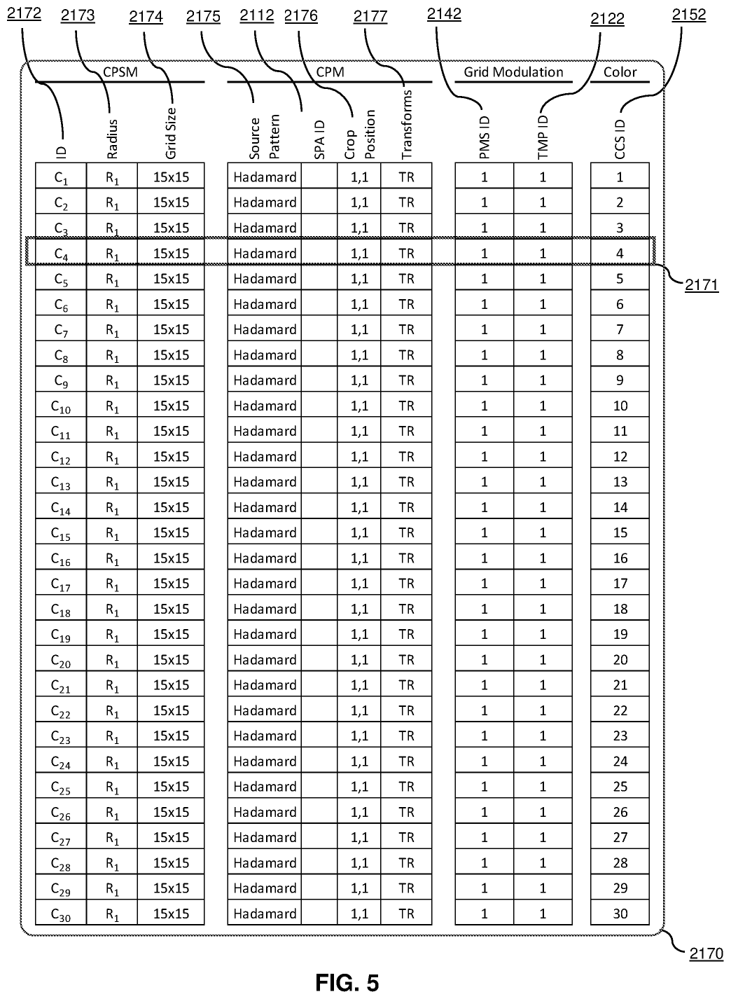

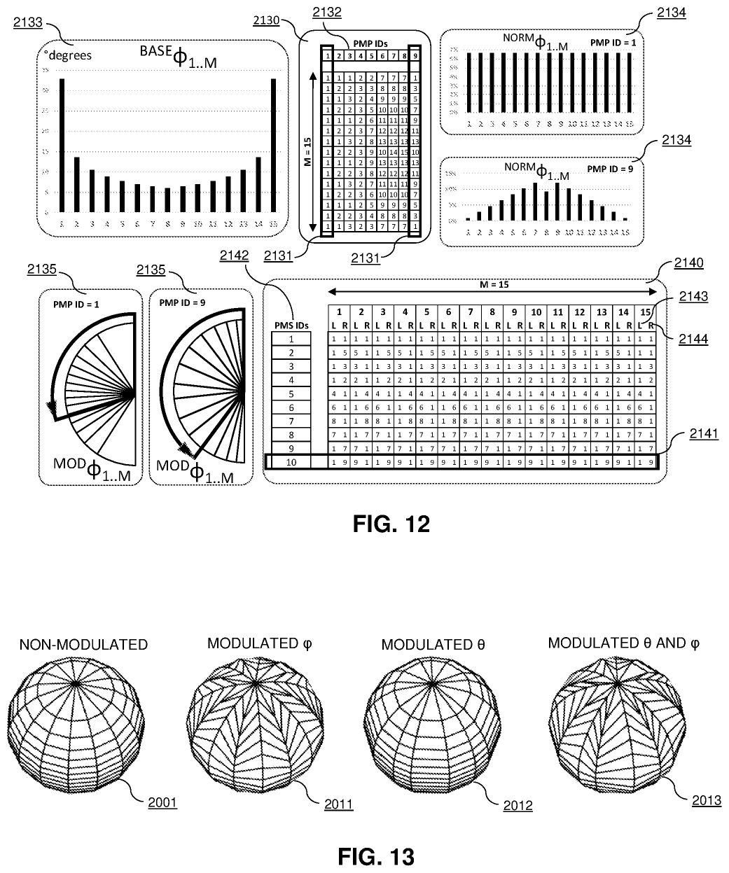

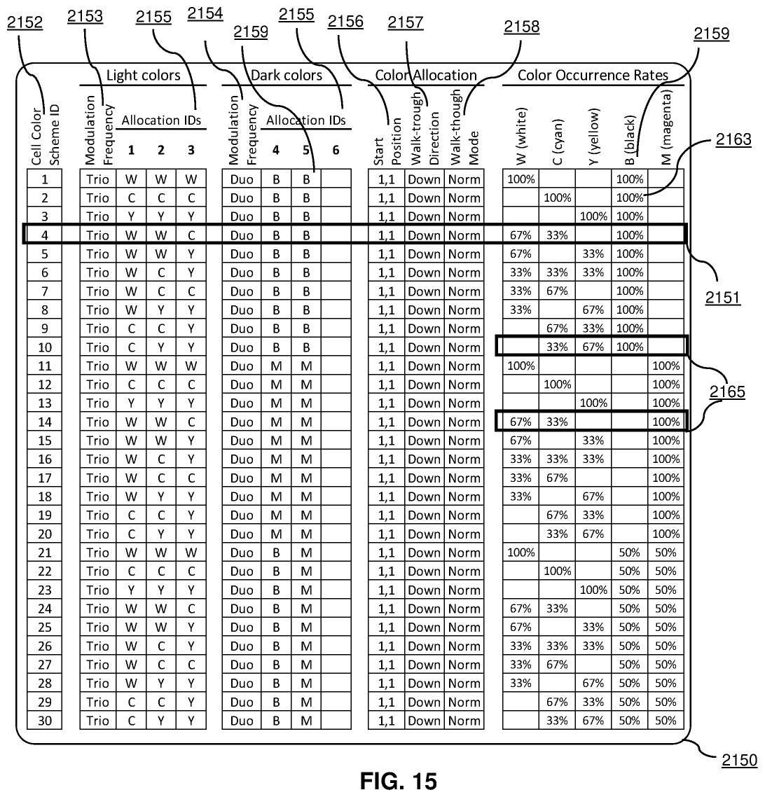

As illustrated in FIG. 2 CPSM parameter stores 2100 comprise Seed Pattern Array (SPA) store 2110, θ (Theta) Modulation Pattern (TMP) store 2120, φ (Phi) Modulation Pattern (PMP) store 2130, φ (Phi) Modulation Scheme (PMS) store 2140, Cell Color Scheme (CCS) store 2150 and parameter set store 2170. FIG. 7 illustrates an example SPA store 2110. SPAs 2111 are heuristic binary vectors that control the content of binary Modulated Pattern Matrix (MPM) 2114, as described in subprocess 2220. A SPA 2111 is identified by SPA ID 2112. An example TMP store 2120 is exhibited on FIG. 11. TMPs 2121 are heuristic numeric vectors that control θ azimuthal angle 2007 modulation. A TMP 2121 is identified by a TMP ID 2122. An example PMP store 2130 and an example PMS store 2140 are exhibited in FIG. 12. PMPs 2131 are heuristic numeric vectors that control φ elevation angle 2008 modulation. A PMP 2131 is identified by a PMP ID 2132. PMSs 2141 are vectors referencing PMPs 2131 by a pair of PMP IDs 2132. A PMS 2141 is identified by a PMS ID 2142. A preferred embodiment CCS store 2150 is exhibited on FIG. 15. A CCS 2151 controls the algorithms that determine the color for all cells 2006. A CCS 2151 is identified by a CCS ID 2152. A preferred embodiment parameter set store 2170 is exhibited in FIG. 5. A parameter set 2171 corresponds to a CPSM design and identified by CPSM ID 2172. A parameter set 2171 stores the world radius 2173 of CPSM 102, the CPSM grid size 2174, the CPM source pattern 2175, the optional SPA ID 2112, the CPM crop position 2176, the CPM transformations 2177, the PMS ID 2142 of PMSs 2141, the TMP ID 2122 of TMP 2121 and the CCS ID 2152 of CCS 2151. In the parameter set store 2170 exhibited on FIG. 5 the plurality of CPSM designs is 30 and the designs are distinguished only by their CCSs 2151.

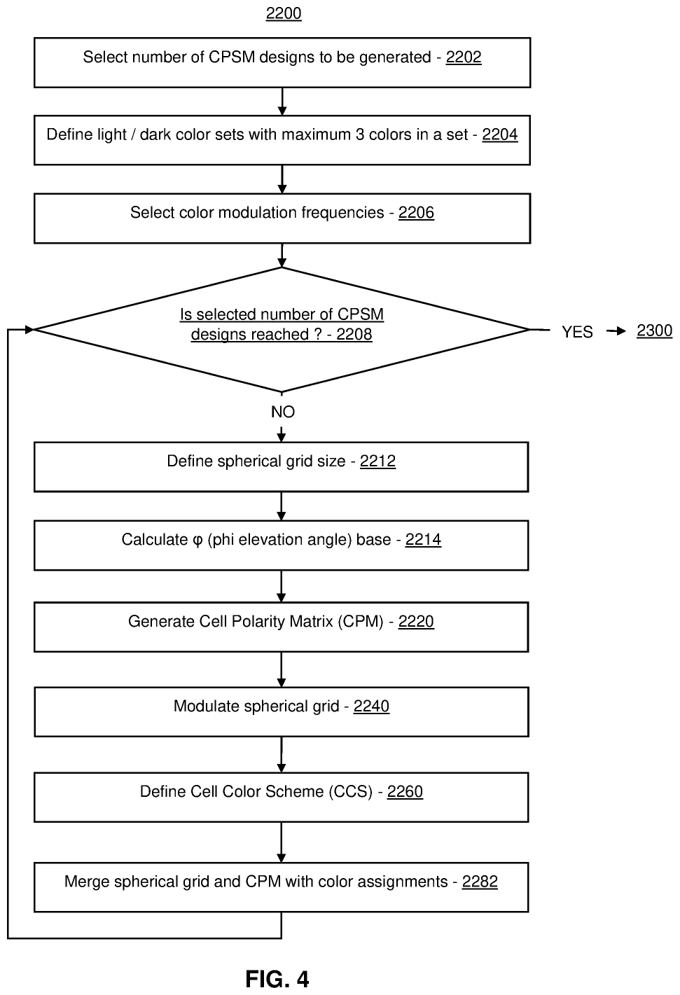

CPSM designer 2200 is illustrated on FIG. 4.

In step 2202 the number of CPSM designs to be generated is selected. Each CPSM design will be stored as a parameter set 2171 in the parameter set store 2170. The number of CPSM designs stored in parameter set store 2170 is not limited. However, if the number of CPSM designs exceeds 100, the accuracy of the trained CPSM recognizer 4500 may be prohibitively low at larger CPSM 102 to camera 101 distances. In a first preferred embodiment the number of CPSM designs is 30. In a second preferred embodiment the number of CPSM designs is 100.

In step 2204 light and dark color sets are defined, with maximum of three different colors in a set. Colors may be defined by the well-known RGB color palettes. All colors shall be distinguishable from one another and belong to the dark or light color set, depending on standard color binarization algorithms, e.g., where RGB color is transformed to gray color and gray color is binarized. In a first preferred embodiment the set for light colors is {white/cyan/yellow} and the set for dark colors is {black/magenta}. In a second preferred embodiment the set for light colors is {white/green/yellow} and the set for dark colors is {black/blue/red}.

In step 2206 color modulation frequencies are selected for both light and dark colors. The selected modulation frequency 2153 determines how many color allocation IDs 2155 out of range {1,2,3} are allocated to the light cell positions in a CPM. Respectively, the selected modulation frequency 2154 determines how many color allocation IDs 2155 out of range {4,5,6} are allocated to the dark cell positions in a CPM. The three possible types of modulation frequencies 2153 and 2154 are called “Mono”, “Duo” and “Trio”. In a first preferred embodiment modulation frequency 2153 is “Trio” and modulation frequency 2154 is “Duo”. In a second preferred embodiment modulation frequency 2153 is “Trio” and modulation frequency 2154 is “Trio”.

In step 2208 the number of generated CPSM designs is checked. If this number equals the number selected in step 2202, CPSM designer 2200 is terminated and passes the control to CPSM renderer 2300.

In step 2212 CPSM grid size 2174 of non-modulated spherical grid 2001 is defined. In a first preferred embodiment CPSM grid size 2174 is 15×15, in a second preferred embodiment CPSM grid size 2174 is 31×31.

In step 2214 ^{BASED}φ_{1 . . . M} (phi base) 2133 values are calculated by utilizing the area equality constraint for cells 2006 of a non-modulated spherical grid 2001, where Σ(^{BASE}φ_{1 . . . M})≡π.

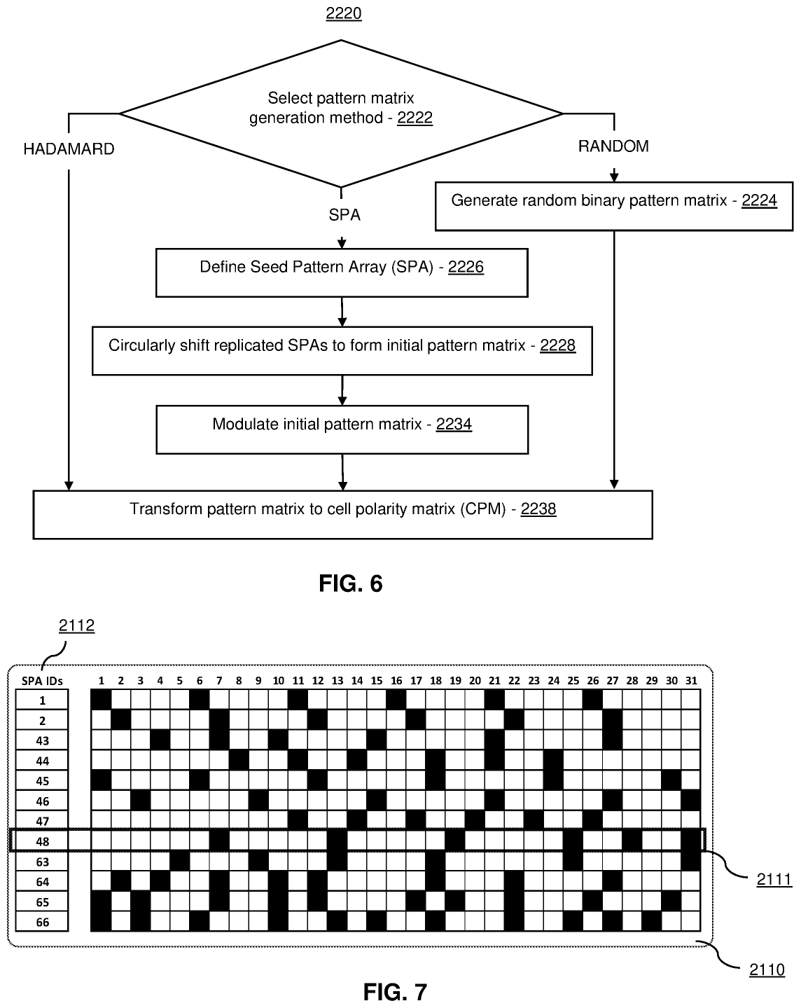

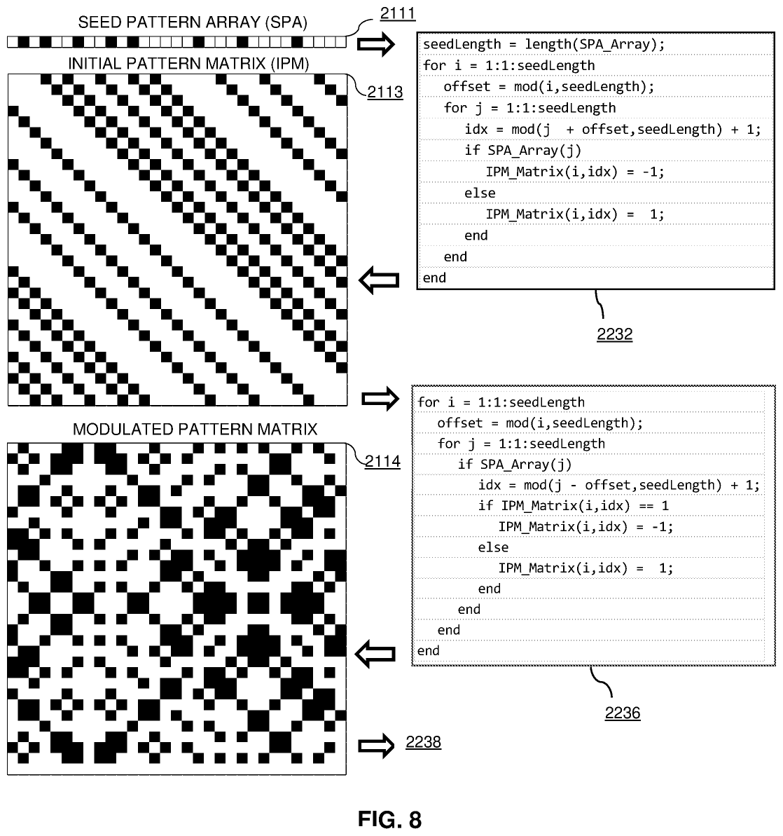

In subprocess 2220 a CPM is generated. Subprocess 2220 is described in FIGS. 6 through 9.

In step 2222 a pattern matrix generation method is selected from three options (i) Hadamard, (ii) random, (iii) SPA based.

In step 2224 a random binary pattern matrix 2116 is generated.

In step 2226 an SPA 2111 with size of N is defined.

In step 2228 the defined SPA 2111 is replicated M times and circularly shifted with incremental shift values ranging from 1 to M, as described by algorithm 2232, to form an Initial Pattern Matrix (IPM) 2113.

In step 2234 the IPM 2113 is modulated by algorithm 2236 to form an MPM 2114.

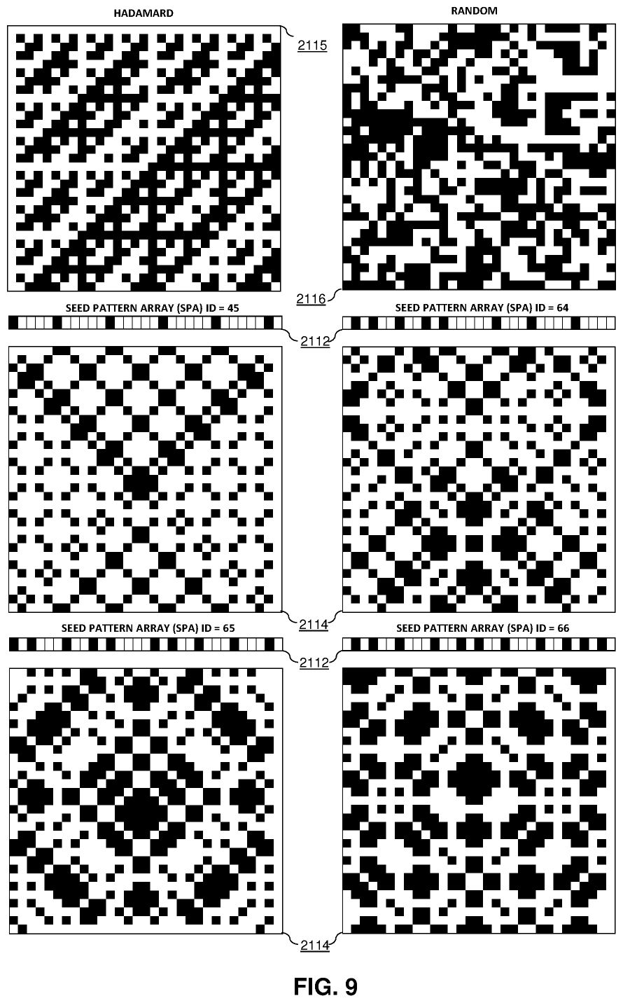

In step 2238 a Hadamard pattern 2115 matrix, a random binary pattern matrix 2116 or an MPM 2114 is transformed to form a CPM. The transformation includes (i) cropping a matrix with CPSM grid size 2174 at CPM crop position 2176 from the underlying pattern matrix 2114 or 2115 or 2116, (ii) optionally transposing the cropped matrix, (iii) optionally mirroring the cropped matrix along the vertical or horizontal axes of symmetry and (iv) optionally rotating the cropped matrix with increments of 90 degrees. Examples of CPM variants are exhibited in FIG. 9. Variant 2115 is a Hadamard pattern CPM, variant 2116 is a random pattern CMP, variants 2114 are SPA based CPMs, all variants are of size N=M=31. In a first preferred embodiment the CPM is (i) of size 15×15, (ii) originated from Hadamard matrices by applying a 15×15 crop from the upper left corner and (iii) transposed. In a second preferred embodiment the CPM is (i) of size 31×31, (ii) originated from Hadamard matrices by applying a 31×31 crop from the upper left corner and (iii) transposed.

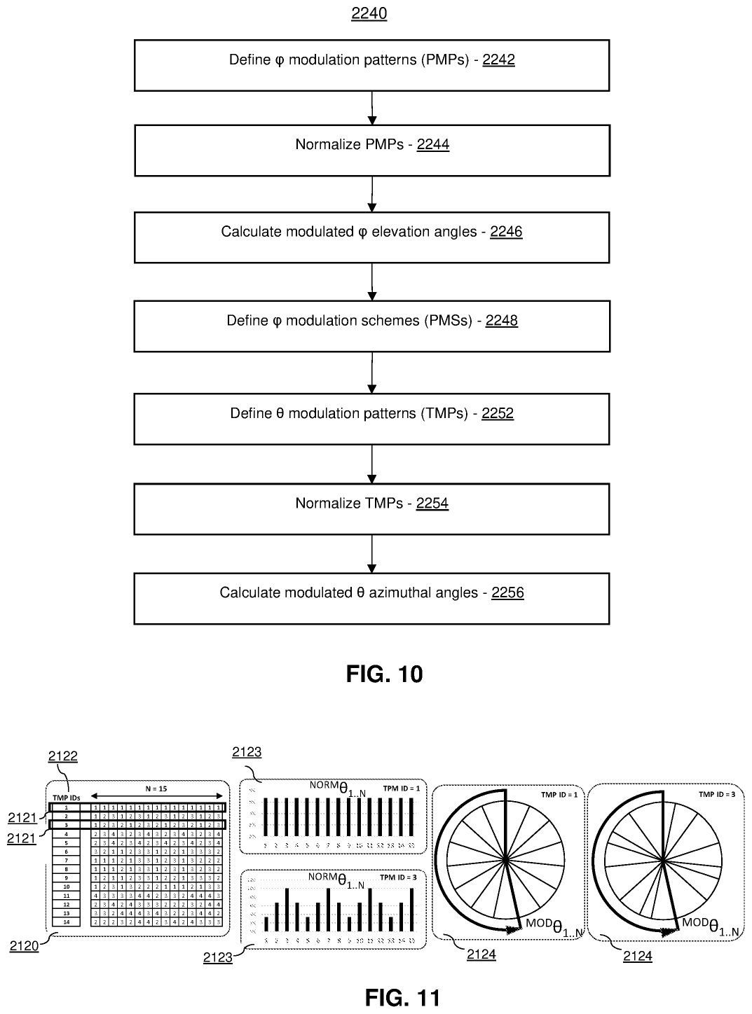

In subprocess 2240 a non-modulated spherical grid 2001 is modulated. Subprocess 2240 is described in FIGS. 10 through 13.

In step 2242 PMPs 2131 are defined.

In step 2244 PMPs 2131 are normalized to ^{NORM}φ_{1 . . . M} 2134 so that Σ(^{NORM}φ_{1 . . . M.}*^{BASE}φ_{1 . . . M})≡π.

In step 2246 modulated φ elevation angles 2135 are calculated as element wise multiplications ^{MOD}φ_{1 . . . M}=^{NORM}φ_{1 . . . M.}*^{BASE}φ_{1 . . . M}.

In step 2248 PMSs 2141 are defined as references to PMPs 2131 with their PMP IDs 2132. The referenced PMPs 2131 are applied when modulating the two—L (left) 2143 and R (right) 2144—longitudinal spherical lines 2002, confining the cells 2006.

In step 2252 TMPs 2121 are defined.

In step 2254 TMPs 2121 are normalized to ^{NORM}θ_{1 . . . N} 2123, so that Σ(^{NORM}θ_{1 . . . N})≡1.

In step 2256 modulated θ azimuthal angles 2124 are calculated as element wise multiplications ^{MOD}θ_{1 . . . N}=^{NORM}θ_{1 . . . N.}*2*π. Example modulations of a non-modulated spherical grid 2001 with CPSM grid size 2174 15×15 are exhibited in FIG. 13. Spherical grid 2001 is non-modulated, spherical grid 2011 is φ modulated, spherical grid 2012 is θ modulated, spherical grid 2013 is both φ and θ modulated. The preferred embodiment spherical grid is a non-modulated spherical grid 2001.

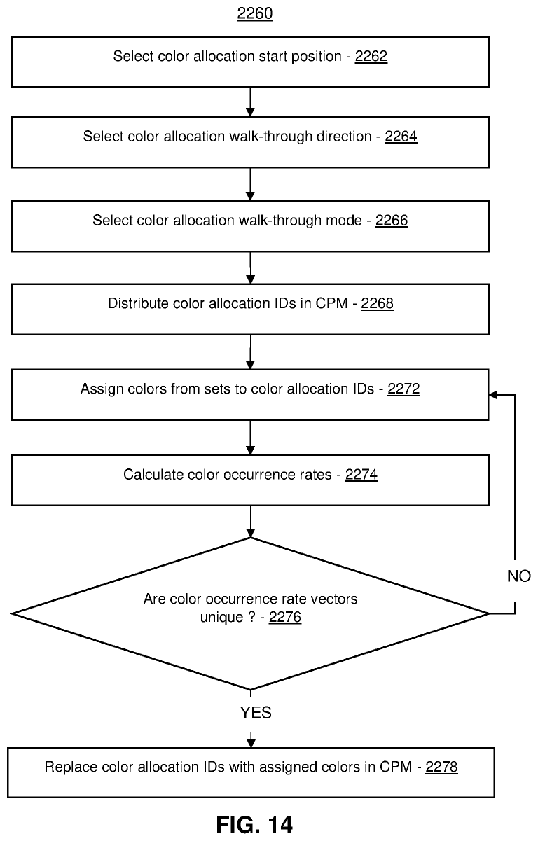

Subprocess 2260 for defining CCSs 2151 is illustrated in FIGS. 14 through 18 and describes how to achieve colorization of cells 2006 where the various members of dark and light color sets defined in step 2204 are (i) evenly distributed on the spherical surface, (ii) the defined CCSs 2151 are distinctive from one another so that a trained CPSM recognizer 4500 could differentiate CPSM IDs 2172 purely based on the color spectrum of a detected CMPS 102.

In step 2262 color allocation start position 2156 is selected. A start position 2156 may be any selected cell of the CPM generated by subprocess 2220. FIG. 17 exhibits a scenario where the start position 2156 is the left upper corner.

In step 2264 color allocation walk-through direction 2157 is selected from the possible range of {up/down/left/right}. FIG. 17 exhibits a scenario where the direction is “down”.

In step 2266 color allocation walk-through mode 2158 is selected from the possible range of {normal/reverse}. FIG. 17 exhibits a scenario where the mode is “normal”.

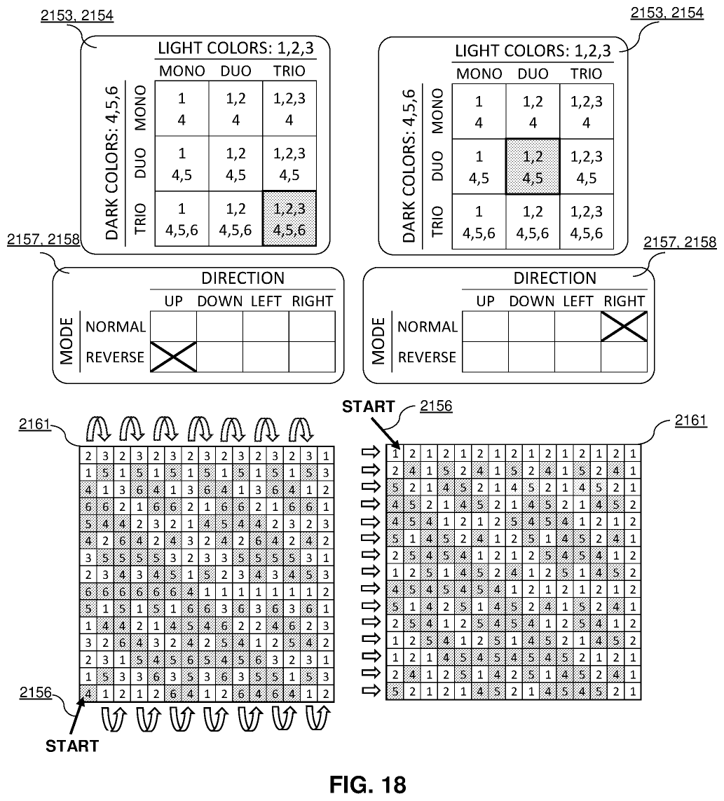

In step 2268 color allocation IDs 2155 are distributed in CPM generated by subprocess 2220. The result of step 2268 is a CPM with color allocations 2161. The range of color allocation IDs 2155 is defined by step 2206. As it can be also understood from the examples exhibited on FIGS. 17 and 18, color allocation IDs 2155—sorted by ID order—are cyclically allocated walking through parallel on dark and light cells, in the selected walk-through direction 2157, starting from the selected start position 2156. When the end of the matrix is reached the selected walk-through mode 2158 determines if walk-through continues from the beginning or the end of the next column/row of CPM. It shall be noted that though many different color allocation ID 2155 distribution variants exist, the occurrence rate of color allocation IDs 2155 in CPM is identical for all distribution variants, irrespective of the selected start position 2156, the selected walk-through direction 2157 and the selected walk-through mode 2158. The occurrence rates of color allocation IDs 2155 in CPM purely depend on the selected color modulation frequencies 2153,2154 and the number of light/dark cells in CPM.

In step 2272 colors 2159 from sets that were defined in step 2204 are assigned to color allocation IDs 2155 present in CPM with color allocations 2161.

In step 2274 color occurrence rates 2163 of assigned colors 2159 are calculated. Color occurrence rates 2163 are calculated separately for light and dark colors, as it is apparently visible in a preferred embodiment CCS store 2150, exhibited in FIG. 15.

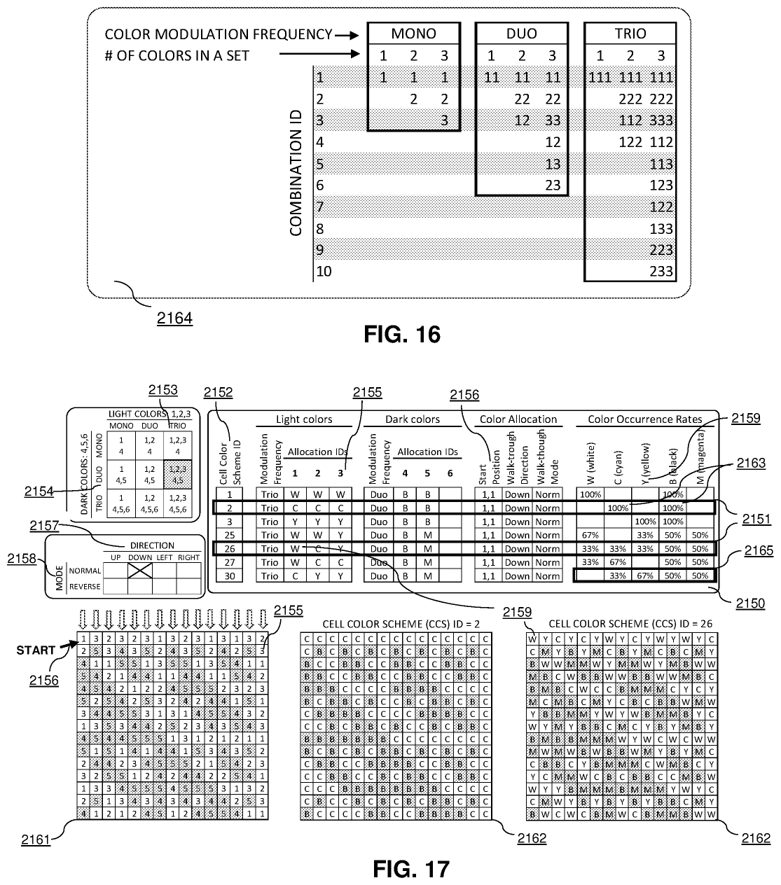

In step 2276 uniqueness of color occurrence rate vectors 2165 across the entire CCS store 2150 is checked. Color occurrence rate vectors 2165 are formed by the ordered sequence of color occurrence rates 2163. If uniqueness of color occurrence rate vectors 2165 is not true, alternative colors 2159 shall be assigned to color allocation IDs 2155 in step 2272. As it can be derived from table 2164 exhibited in FIG. 16 the first preferred embodiment color set combined with the first preferred embodiment color modulation frequencies provide a maximum of 30 unique color occurrence rate vectors 2165, the second preferred embodiment color set combined with the second preferred embodiment color modulation frequencies provide a maximum of 100 unique color occurrence rate vectors 2165.

In step 2278 color allocation IDs 2155 are replaced with assigned colors 2159 in the CPM with color allocations 2161 to create a CPM with color assignments 2162.

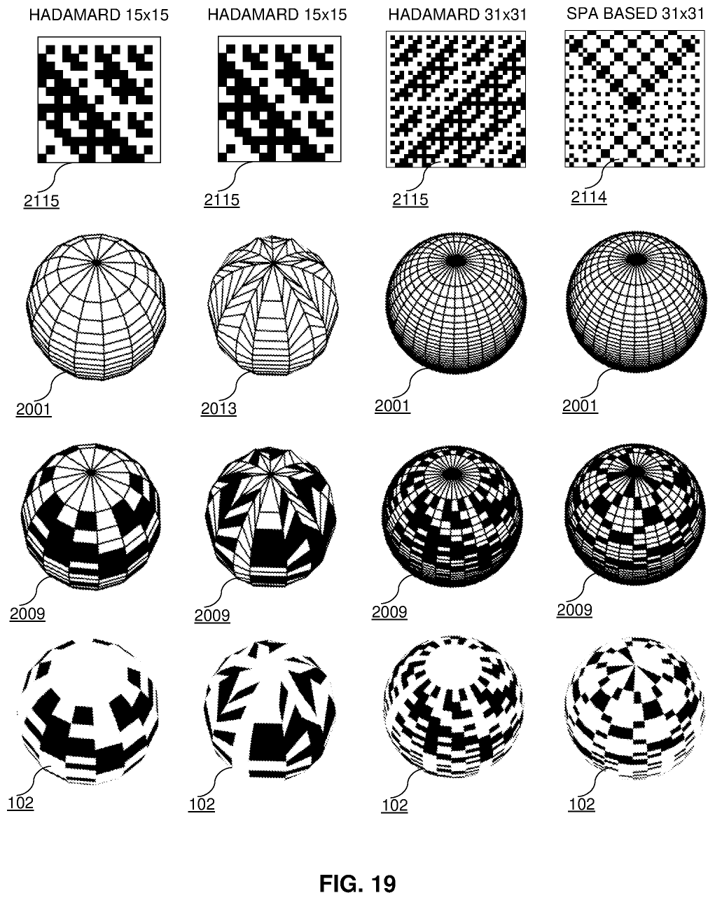

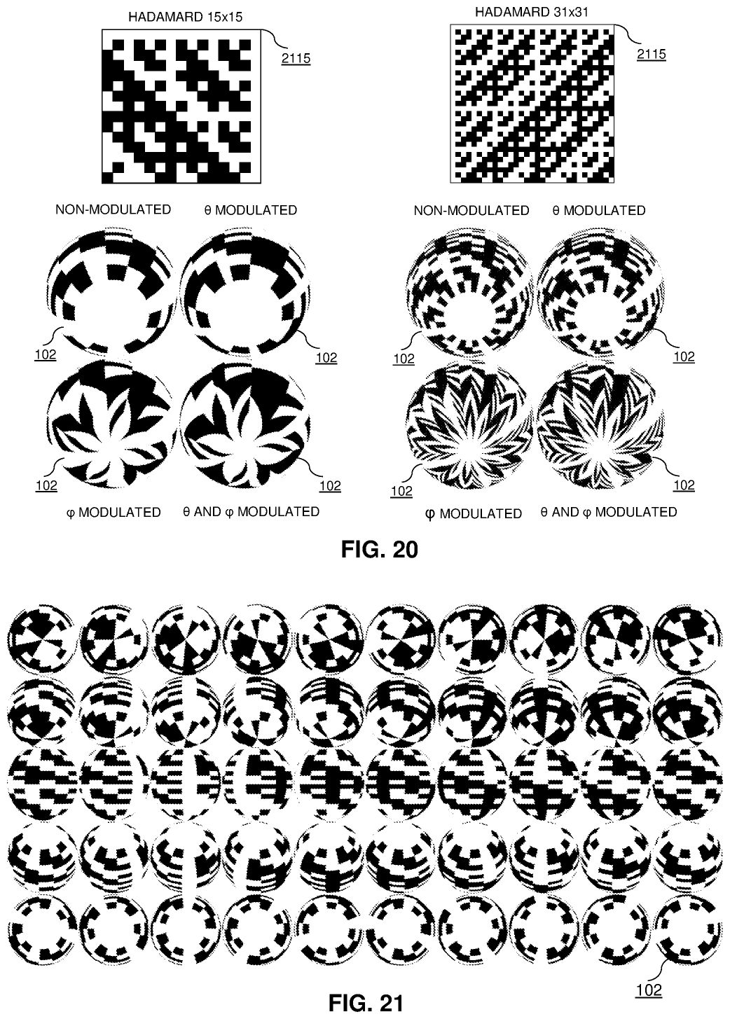

In step 2282 the spherical grid created by process 2240 and the CPM with color assignments 2162 is merged so that so that the top and bottom rows of the CPM with color assignments 2162 become spherical triangles 2004. By completion of step 2282 the color and the spherical coordinates of corners of all cells 2006 of a CPSM 102 are defined. Merged spherical grids and CPMs 2009 are exhibited in FIG. 19. The visual effect of spherical grid modulations merged with the first and second preferred embodiment CPM is illustrated in FIG. 20.

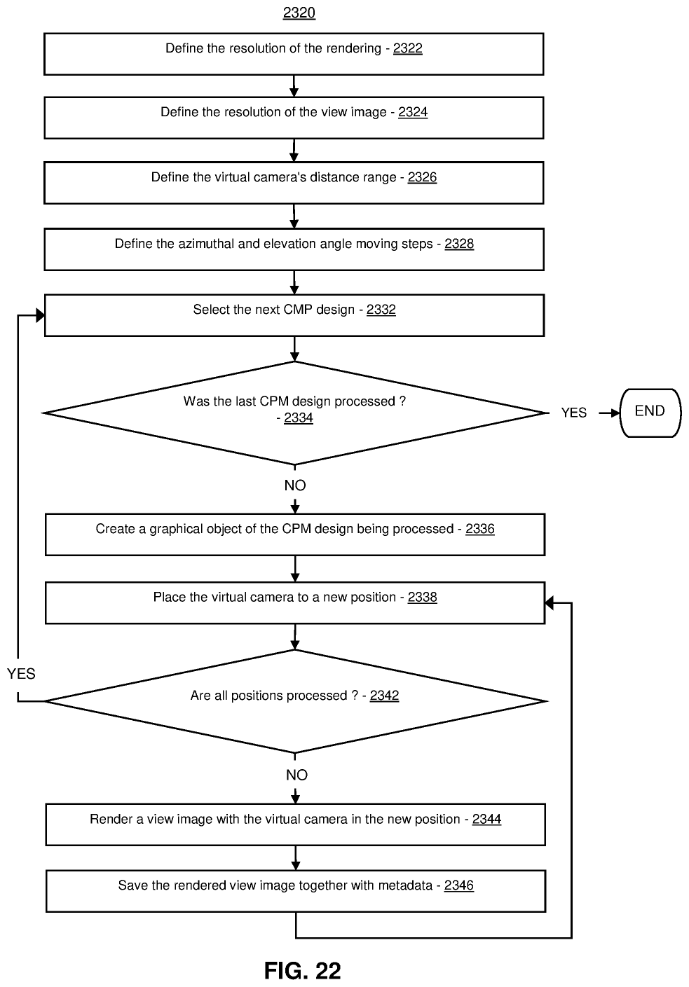

View renderer process 2320 is exhibited in FIG. 22 and describes the steps of generating Synthetic View Images (SVIs) from plurality of virtual camera positions.

In step 2322 the resolution factor of rendering is determined. The resolution factor of rendering determines how many child cells of the cells 2006 are created to achieve a photorealistic spherical-shape SVI being rendered. The child cells carry the same color as their corresponding parent cells 2006 and the spherical coordinates of child cells' corners are calculated by linear interpolation of the corresponding parent cells' 2006 spherical coordinates. In a preferred embodiment the resolution factor of rendering for a spherical grid size of 15×15 is 10, for a spherical grid size of 31×31 is 5.

In step 2324 the pixel resolution of the rendered SVI is determined. The higher the resolution the more rendering processing time is required. In a preferred embodiment the resolution of the rendered SVI is 400×400 pixels.

In step 2326 the virtual camera's distance range is determined. Considering the practical uses cases where CPSMs 102 are applied it can be assumed that the maximum radius of a CPSM 102 is 30 cm combined with a minimum of camera 101 to CPSM 102 distance being 100 cm. The minimum radius of a CPSM 102 is 3 cm which can be reliably detected with an 8-megapixel camera from a distance to camera 101 of 7 meters. The virtual camera's lower and higher end distances can be calculated based on these radius and world distance constraints.

In step 2328 azimuthal angle 2007 and elevation angle 2008 sectioning is determined. Sectioning means dividing the azimuthal angle 2007 range of {0 . . . 2π} and elevation angle 2008 range of {0 . . . π} to equal-size sections. When the next new position of the virtual camera is calculated in step 2338 a random value from an azimuthal angle and elevation angle section is being generated. In a preferred embodiment azimuthal angle 2007 range of {0 . . . 2π} is divided to 200, elevation angle 2008 range of {0 . . . π} is divided to 100 sections.

In step 2332 the next CPSM design is selected by fetching the next parameter set 2171 from parameter set store 2170.

In step 2334 the completeness of parameter set store 2170 processing is checked.

In step 2336 a graphical object of the CPM design being processed is created. Data in a parameter set 2171 together with the algorithms described in CPSM designer 2200 and the resolution factor of rendering determined in step 2322 fully specify a graphical object that can be used for rendering SVIs at various virtual camera positions.

In step 2338 the virtual camera is placed into a new position. An azimuthal and an elevation angle section combination is selected and a random azimuthal angle 2007 and elevation angle 2008 value is generated from the selected azimuthal and elevation angle sections, respectively. A random distance value is also generated in the virtual camera's distance range, determined in step 2326. The virtual camera's position is determined in the spherical coordinate system of the graphical object created in step 2336.

In step 2342 it is checked if all azimuthal and elevation angle section combinations are visited.

In step 2344 an SVI is rendered of the graphical object created in step 2336, the virtual camera being in the position determined in step 2338, the pixel resolution of rendering being determined in step 2324.

In step 2346 the rendered SVI and the associated metadata are stored in a datastore. The datastore is feeding view augmenter process 2350. The metadata comprises (i) the CPSM ID 2172, (ii) the value of random azimuthal angle 2007, (iii) the value of random elevation angle 2008, (ii) through (iii) being determined in step 2338. FIG. 21 shows SVIs of a preferred embodiment bicolor CPSM 102, its design being originated from Hadamard pattern 2115, with non-modulated spherical grid 2001 of size 15×15. The columns represent five rendered SVIs with elevation angles 2008 being evenly distributed in the {0 . . . π} range, the rows represent ten rendered SVIs with azimuthal angles 2007 being evenly distributed in the {0 . . . 2π} range.

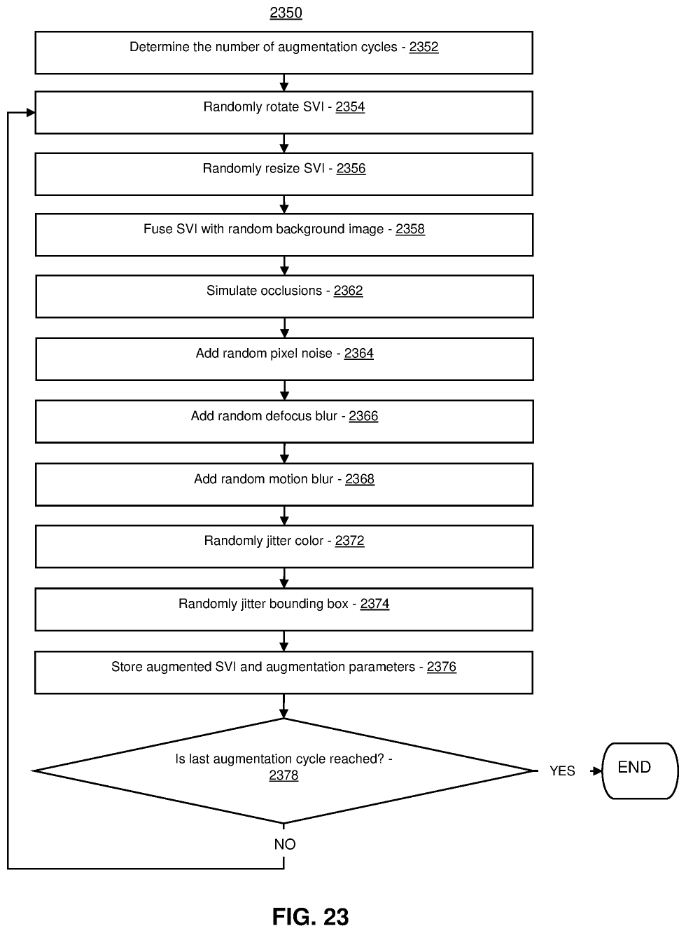

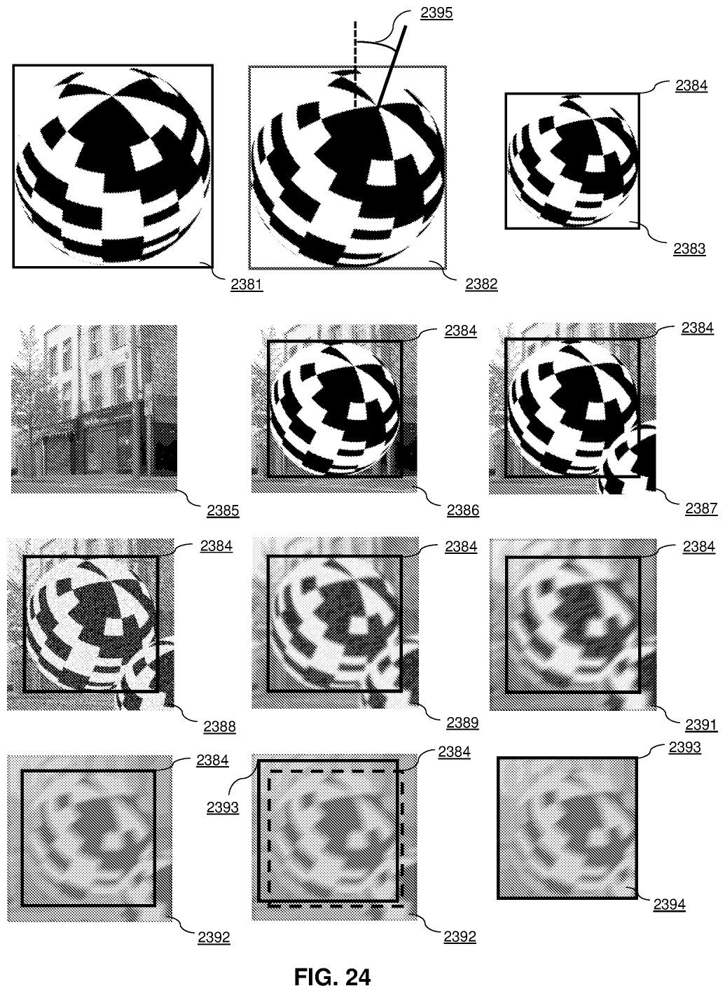

View augmenter process 2350 is exhibited in FIGS. 23 and 24 and describes the steps of replicating and augmenting the SVIs generated by view renderer process 2320.

In step 2352 the number of augmentation cycles is determined. All SVIs generated by view renderer process 2320 are synthetic images with identical image size and it is well known to those skilled in the art that images used for training learning-based models need to be augmented for various image rotation, image size and image noise artifacts to achieve a trained learning-based model that is functional in real case imaging scenarios. The number of augmentation cycles controls how many Augmented Synthetic View Images (ASVIs) 2394—using an SVI as a source—are made.

In step 2354 an SVI 2381 is rotated by a random roll angle 2395 in the range of {0 . . . 2π} to create image 2382. The size of image 2382 is the same as the size of the SVI 2381.

In step 2356 image 2382 is resized by a random factor in the range of {0 . . . 1} to create image 2383 that has a square-shaped bounding box 2384.

In step 2358 image 2383 is fused with a randomly selected background image 2385 to create image 2386.

In step 2362 occlusions are simulated by fusing occlusion artifacts with image 2386 to create image 2387.

In step 2364 random pixel noise is added to image 2387 to create image 2388.

In step 2366 random defocus blur is applied on image 2388 to create image 2389.

In step 2368 random motion blur is applied on image 2389 to create image 2391.

In step 2372 the color of image 2391 is randomly jittered to create image 2392.

In step 2374 square-shaped bounding box 2384 is randomly jittered both in size and position, to form a new square-shaped bounding box 2393. Bounding box jittering simulates object detection inaccuracies. ASVI 2394 is created by cropping image 2392 by bounding box 2393.

In step 2376 ASVI 2394 and extended metadata is stored in a datastore that is feeding training stores 3100, 4100 and 5200. Extended metadata comprises the metadata created in step 2346, roll angle 2395 and noise score, calculated from the random noise parameters applied in steps 2364 through 2374.

In step 2378 it is checked if all augmentation cycles are executed. In a preferred embodiment the number of the augmentation cycles in step 2352 is set to 200 or more.

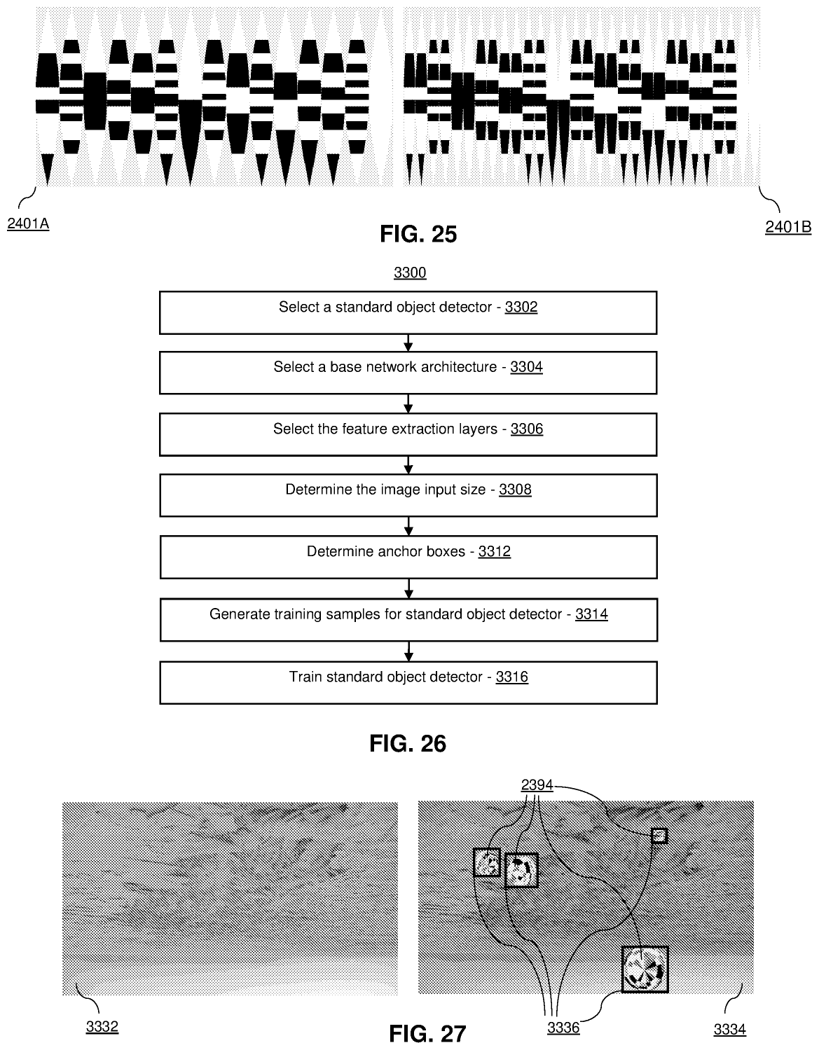

CPSM tesselator 2400 generates a two-dimensional tessellation sheet for each CPSM design instance that is present in parameter set store 2170. Tessalation sheets may be re-scaled, printed, cut at its pattern contours for the purpose of the colored patterns being applied to a spherical surface to function as CPSMs 102. Examples of tessellation sheets are illustrated in FIG. 25. Tesselation sheets 2401A and 2401B are composed for a preferred embodiment CPSM design, originated from Hadamard pattern 2115, with non-modulated spherical grid 2001 of size 15×15. Tesselation sheet 2401B is a leaf-split version of tesselation sheet 2401A.

Detection trainer 3300 is illustrated in FIGS. 26 and 27 and describes the steps of training the learning-based part—referred to as object detector—of CPMS detector 3500.

In step 3302 an object detector type is selected. An object detector type can be any of the widely used and standard object detectors, like SSD, Yolo. In a preferred embodiment Yolov4 is selected as object detector.

In step 3304 a base network architecture is selected for object detector. In a preferred embodiment MobileNetv2 is selected as network architecture.

In step 3306 feature extraction layers of object detector are selected.

In step 3308 the image input size of object detector is determined. In a preferred embodiment the image input size is 1024*1024*3.

In step 3312 the anchor boxes of object detector are determined.

In step 3314 training samples 3110 are generated. As illustrated in FIG. 27, a training sample 3110 is generated by fusing a randomly selected non-synthetic background image 3332 with randomly selected ASVIs 2394 at randomly selected background image locations, to form a training image 3334. The background image 3332 is first rescaled to the image input size—determined in step 3308—then fused with ASVIs 2394. The size of the ASVIs' 2394 square-shaped bounding boxes 3336 is determined in step 2374 and is retrieved from the extended metadata of the datastore, updated in step 2376. Training samples 3110 comprise (i) the training image 3334, (ii) the randomly selected locations of ASVIs 2394, (ii) the size of bounding boxes 3336. Training samples 3110 are stored in detection training store 3100.

In step 3316 the object detector is trained with training samples 3110. Training an object detector is a well-known task to those skilled in the art, which may include re-running view augmenter 2340 and step 3314 to obtain new training samples 3110. In a preferred embodiment object detector is trained for a single object category, in other words, object detector is not expected to predict the detected CPSMs' IDs 2172, as CPSM IDs 2172 are predicted by CPSM recognizer 4500. In a preferred embodiment ASVIs 2394 with bounding box 3336 smaller then 20×20 pixels are ignored in the training sample generation step 3314, as the image texture of small ASVIs 2394 is not adequately distinctive relative to the background and a trained object detector may produce too many false positive detections.

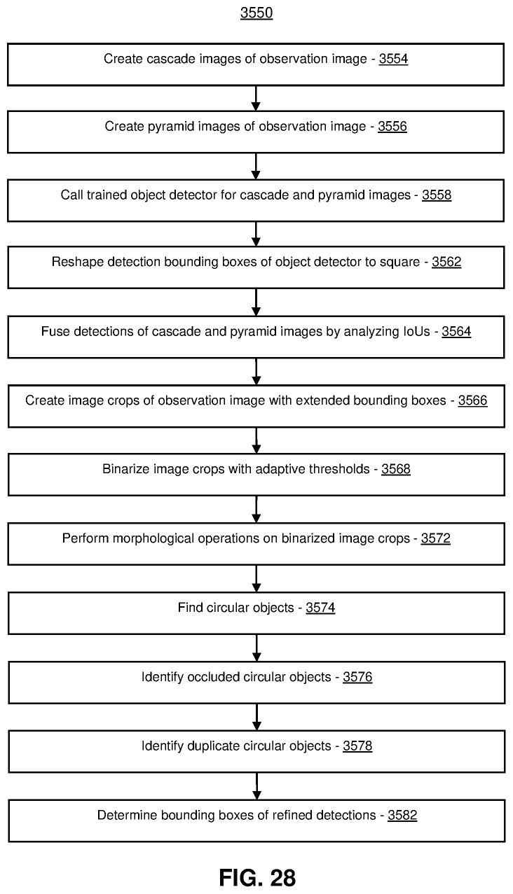

CPSM detector 3500 comprises a trained object detector and a CPSM detection process 3550, exhibited in FIGS. 28 through 31.

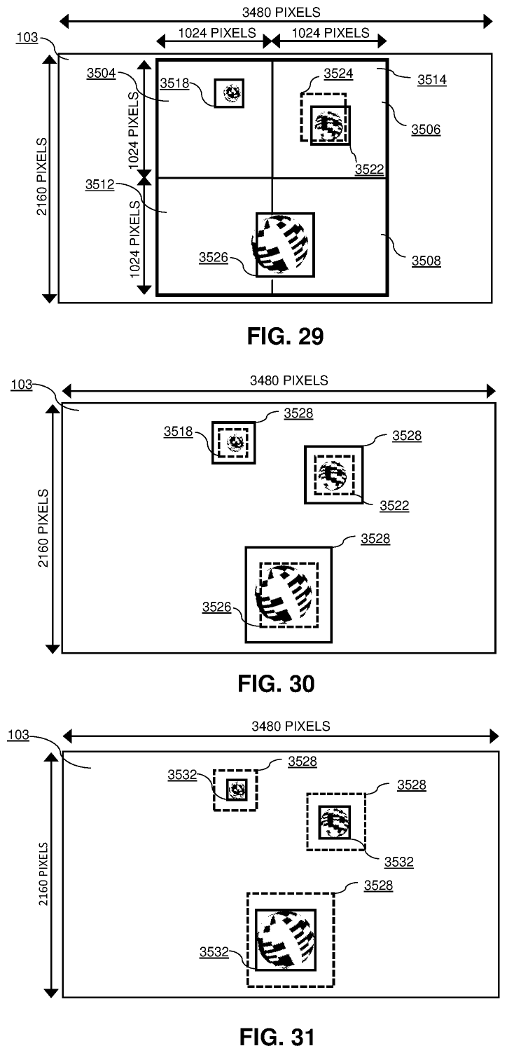

In step 3554 an observation image 103 is cascaded to images that have the same size as the input image size of the trained object detector. In an example illustrated in FIG. 29 four cascaded images 3504, 3506, 3508 and 3512 are created.

In step 3556 pyramid images—mipmaps—are created from observation image 103 so that the pyramid images have the same size as the input image size of the trained object detector. In the example illustrated on FIG. 29 one pyramid image 3514 is created by union of cascade images 3504, 3506, 3508 and 3512, rescaled to the input image size of the trained object detector.

In step 3558 the trained object detector is called, with inputs being the cascade images and pyramid images created in steps 3554 and 3556.

In step 3562 the rectangular-shaped detection bounding box responses of object detector are (i) rescaled to the observation image 103 pixel-coordinates, (ii) reshaped to square so that the areas and centers of rectangles and squares are identical. In the example illustrated in FIG. 29 the trained object detector returns detections with square-shaped bounding boxes 3518, 3522, 3524 and 3526. Bounding box 3518 originates from cascade image 3504, bounding box 3522 originates from cascade image 3506, bounding boxes 3524 and 3525 originate from pyramid image 3514. As it is visible in FIG. 29 bounding boxes 3522 and 3524 detect the same CMPS 102.

In step 3564 the Intersection over Union (IoU) of all square-shaped detection bounding box pairs is analyzed, to eliminate duplicate detections. In the example exhibited in FIG. 29 a detection with bounding box 3524 is eliminated.

In step 3566 images are cropped from observation image 103 with extended bounding boxes 3528, as illustrated in FIG. 30.

In step 3568 the image crops created in step 3566 are binarized with adaptive thresholds.

In step 3572 the binarized image crops, created in step 3568 are subjected to morphological operations (i) dilation, (ii) filling holes, (iii) opening, in a preferred embodiment with a disk structural element, the size of the disk structural element being a pre-determined proportion of the size of the binarized image crops.

In step 3574 circular objects are searched for in the binary images created in step 3572, by applying Hough transforms and/or calculating object metrics for roundness.

In step 3576 occluded circular objects are identified and heavily occluded circular objects are eliminated.

In step 3578 duplicate circular objects are identified and duplications are eliminated.

In step 3582 Refined Square-shaped detection Bounding Boxes (RSBBs) 3532 are determined by rescaling the results of steps 3574 through 3578 to the observation image 103 pixel-coordinates. Examples for RSBBs 3532 are exhibited in FIG. 31.

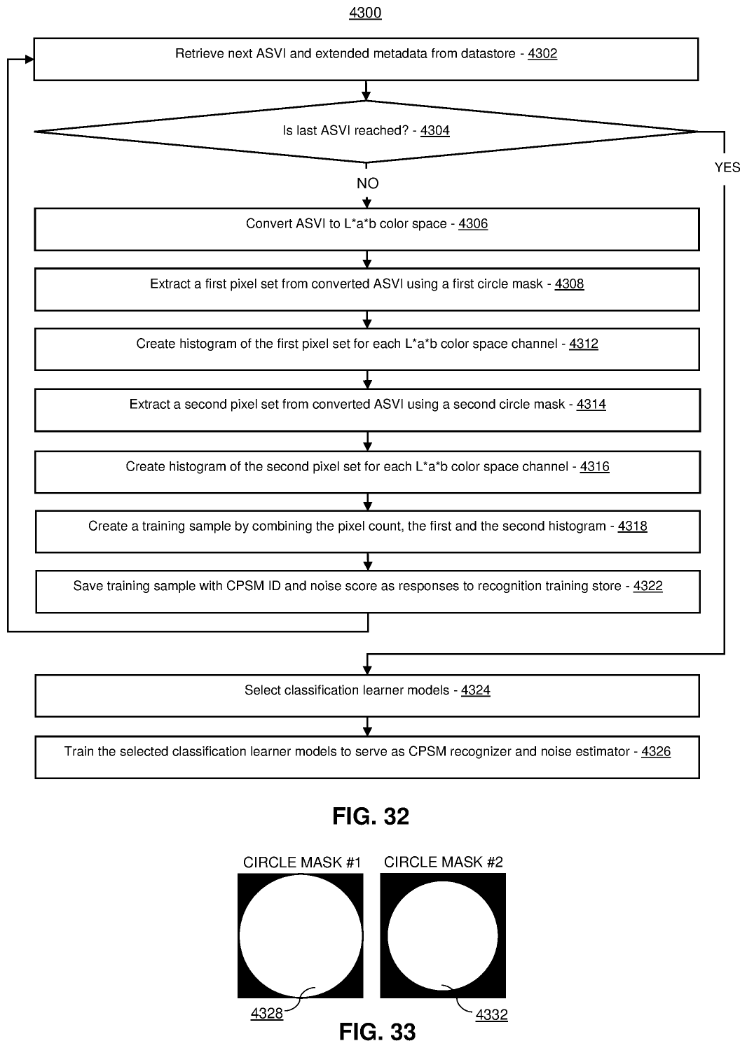

Recognition trainer 4300 is illustrated in FIGS. 32 and 33 and describes the steps of training a learning based CPMS recognizer 4500 and noise estimator 6500.

In step 4302 an ASVI 2394 is retrieved from the datastore created by CPSM renderer 2300, together with the associated CPMS ID 2172 and noise score, stored in the datastore as extended metadata.

In step 4304 it is checked if all ASVIs 2394 are processed to serve as a training sample 4110 in recognition training store 4100.

In step 4306 the ASVI 2394 is converted to L*a*b color space.

In step 4308 a first circle mask 4328 is resized to the size of the ASVI 2394 and is used to extract a first pixel set from the ASVI 2394.

In step 4312 histograms of the extracted first pixel set are created, for each L*a*b color space channel, using nb_{L}, nbₐ and nb_{b} number of bins, respectively.

In step 4314 a second circle mask 4332 is resized to the size of the ASVI 2394 and is used to extract a second pixel set from the ASVI 2394. The radius of circle in mask 4332 is a pre-established ratio of the radius of circle in mask 4328. In a preferred embodiment the said pre-established ratio equals 0.9.

In step 4316 histograms of the extracted second pixel set are created, for each L*a*b color space channel, using nb_{L}, nbₐ and nb_{b} number of bins, respectively. In the preferred embodiment parameter set stores 2170 the color spectrum of both the extracted first pixel set and the extracted second pixel set is characteristic to the CPSM's design. Therefore, the bin counts can serve as predictor features for a learning-based classification model to predict CPSM ID 2172.

In step 4318 a training sample 4110 is created by combining the number of extracted pixels and the histogram bin counts of the first and the second pixel sets as predictor features with CPSM ID 2172 and noise score as responses. The number of predictor features in training sample 4110 is 2*(nb_{L}+nbₐ+nb_{b})+1. In a preferred embodiment nb_{L}=3, nbₐ=8 and nb_{b}=8. In step 4322 the training sample 4110 is saved to recognition training store 4100. It is noted here that the use of a second pixel set in steps 4314 through 4318 is optional. In step 4324 a first and a second classification learner model is selected to serve as CPSM recognizer 4500 and noise estimator 6500, respectively. In a preferred embodiment bi-layered neural networks are used as first and second classification learner models. In step 4326 the selected first and second classification learner models are trained, using the training samples 4110 stored in the recognition training store 4100. To those skilled in the art training a classification learner model is a well-known task that may include re-running view augmenter 2340 and steps 4302 through 4322 to obtain new training samples 4110.

CPSM recognizer 4500 and noise estimator 6500 comprises the first and the second classification learner models, respectively, selected and trained in steps 4324 and 4326. Both CPSM recognizer 4500 and noise estimator 6500 are called when their input predictor features are determined by (i) cropping observation image 103 by an RSBB 3532, (ii) converting the image crop to L*a*b color space, (iii) calculating the histogram bin counts, as described in steps 4308 through 4318. In the preferred embodiments CPSM recognizer 4500 returns a probability for each CPSM ID 2172, noise estimator 6500 returns a probability for each noise score.

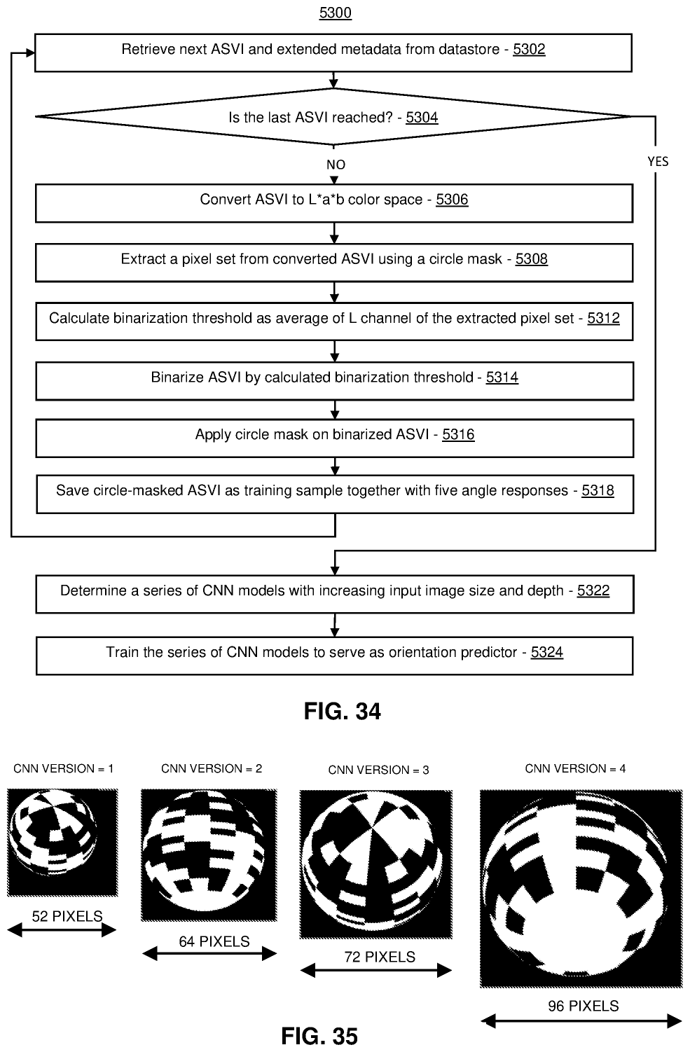

Orientation trainer 5300 is illustrated in FIGS. 34 through 36 and describes the steps of training a learning-based orientation predictor 5500.

In step 5302 an ASVI 2394 is retrieved from the datastore created by CPSM renderer 2300, together with the associated azimuthal angle 2007, elevation angle 2008 and roll angle 2395, stored in the datastore as extended metadata.

In step 5304 it is checked if all ASVIs 2394 are processed to serve as training samples 5210 in orientation training store 5200.

In step 5306 the ASVI 2394 is converted to L*a*b color space.

In step 5308 a circle mask 4328 is resized to the size of the ASVI 2394 and is used to extract a pixel set from the ASVI 2394.

In step 5312 a binarization threshold is calculated, being the average of L channel of the extracted pixel set.

In step 5314 ASVI 2394 is binarized by applying a binarization threshold calculated in step 5312.

In step 5316 a circle mask 4328 is applied on binarized ASVI 2394 to set the pixels outside the circle to binary value 0.

In step 5318 the circle-masked ASVI 2394 is saved as training sample 5210 in orientation training store 5200 together with associated response metadata (i) azimuthal angle 2007, (ii) elevation angle 2008, (iii) roll angle 2395, (iv) APR angle, calculated as sum of azimuthal angle 2007 and roll angle 2395 and (v) AMR angle, calculated as difference of azimuthal angle 2007 and roll angle 2395. APR angle and AMR angle may be increased/decreased with angle 2π so that the resulting angles fall in the range of {0,2π}.

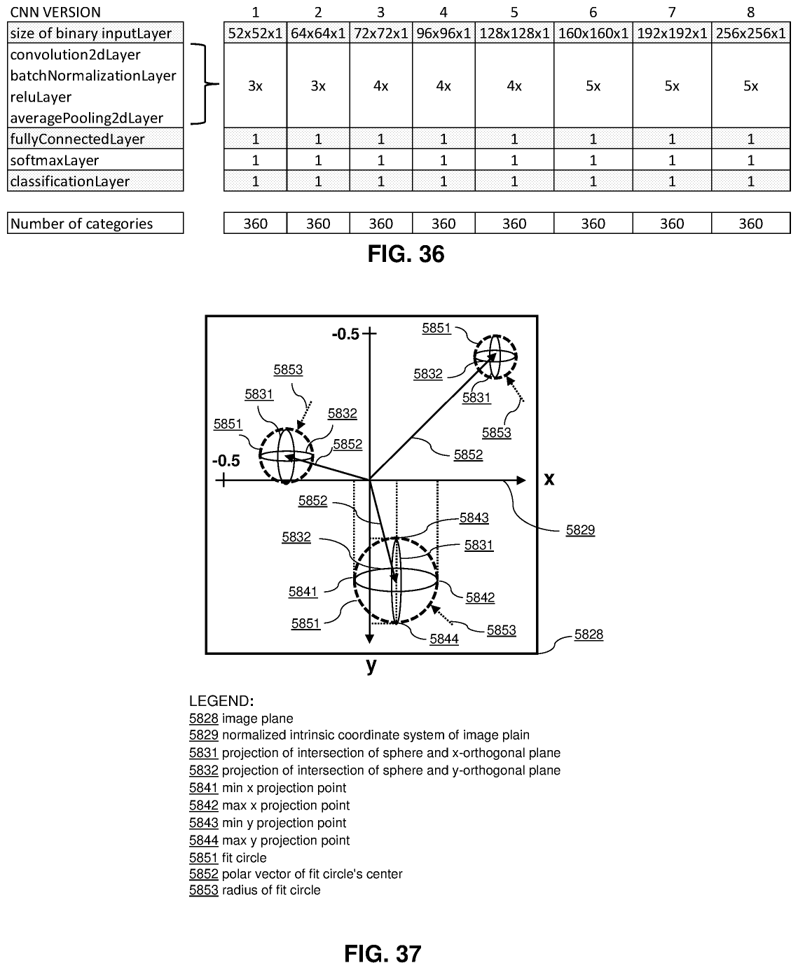

In step 5322 a series of Convolutional Neural Network (CNN) models with increasing input image size and depth is determined to serve as orientation predictor 5500. A preferred embodiment series of CNN models is exhibited in FIG. 36. The CNN architecture of CNN versions 1 through 8 and the commonly applied filter parameters are well-known to those skilled in the art. All CNN versions are designed to predict angle degree values in the range of {0 . . . 180°} or {0 . . . 360°}. Classification CNNs are used instead of regression CNNs to avoid the circular singularity problem of 0 versus 360 degrees.

In step 5324 the series of CNN models are trained to predict five angles 2007,2008,2395, APR and AMR, to serve as orientation predictor 5500. All CNN model versions with their five angle response variants may be trained separately. The varying-size ASVIs 2394—stored as training samples 5210—are used to train only the best-size-fit CNN model version and are copied to the upper left corner of the CNN's input layer, as illustrated on FIG. 35. To those skilled in the art training CNNs with architecture summarized in FIG. 36 in a well-known task, which may include re-running view augmenter 2340 and steps 5302 through 5318 to obtain new training samples 5210.

Orientation predictor 5500 comprises the series of CNN models determined and trained in steps 5322 and 5323. The five angle response variants of orientation predictor 5500 are called when their binary input image is determined by (i) cropping observation image 103 by an RSBB 3532, (ii) converting the image crop to L*a*b color space, (iii) masking the converted image crop with circle mask 4328, (iv) calculating the binarization threshold as average of the L channel of pixel set determined by circle mask 4328, (v) binarizing the masked image crop, using the calculated binarization threshold. The size of the binarized masked image crop determines which CNN version shall be called. An image re-sizing may be required if the size of the binarized masked image crop exceeds the size of the largest-input-image-size CNN version. The binarized masked image crop shall be copied to the upper left corner of the input layer of the corresponding CNN.

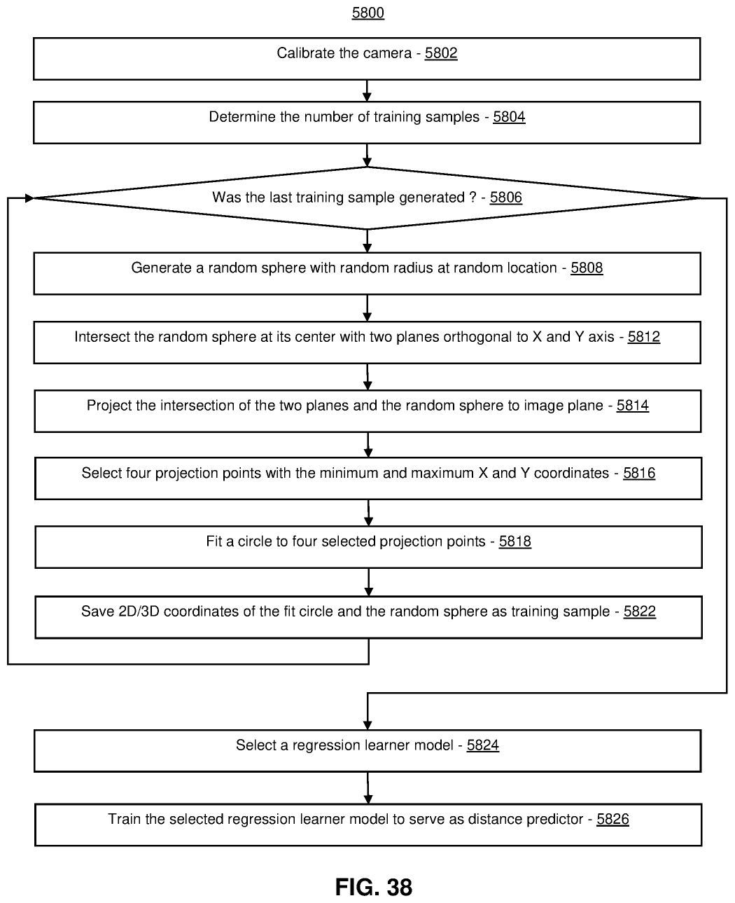

Distance trainer 5800 is illustrated in FIGS. 37 and 38 and describes the steps of training a learning-based distance predictor 5900.

In step 5802 camera 101 is calibrated. Camera calibration is a well-known task to those skilled in the art. Once calibrated, any 3D point's coordinates in the camera's 101 intrinsic coordinate system 5854 can be projected to image plane 5828 by calculating its 2D coordinates in the image plane's 5828 normalized coordinate system 5829.

In step 5804 the number of synthetic training samples to be generated is determined.

In step 5806 it is checked if all synthetic training samples were generated.

In step 5808 a random sphere with random world radius 2173 R at random location is generated.

In step 5812 the random sphere is intersected at its center with two planes, the first plane being orthogonal to the X and the second plane being orthogonal to the Y axis of the camera's 101 intrinsic coordinate system 5854.

In step 5814 the intersection of the two planes and the random sphere is projected to image plane 5828 to form projection ellipses 5831 and 5832. Projection is executed by selecting plurality of 3D points and calculating the 2D coordinates of these points in coordinate system 5829.

In step 5816 four points 5841,5842,5843 and 5844 of projection ellipses 5831 and 5832 are selected, these points having the minimum and maximum X and Y coordinate values in coordinate system 5829.

In step 5818 a circle 5851 is fit to the four selected projection points 5841,5842,5843 and 5844, using the least square error method.

In step 5822 (i) normalized radius 5853, (ii) polar vector's 5852 length 5855, (iii) the random sphere's world radius 2173 R, (iv) the random sphere's distance to origin 5856, (v) the random sphere's distance to the Z axis 5857 of the camera's 101 intrinsic coordinate system 5854 are saved as training sample, 5853,5855,2173 being predictor features and 5856,5857 being responses.

In step 5824 a regression learner model is selected to serve as distance predictor 5900. In a preferred embodiment a bi-layered neural network is used as a regression learner model.

In step 5826 the selected regression learner model is trained using the training samples generated in steps 5808 through 5822. To those skilled in the art training a regression learner model is a well-known task that may include re-running steps 5808 through 5822 to obtain new training samples.

Distance predictor 5900 comprises the regression learner model selected and trained in steps 5824 and 5826. Distance predictor 5900 is called when its input predictor features are determined by (i) normalizing the coordinates of an RSBB 3532 to the observation image 103 pixel-coordinates, (ii) determining the CPSM ID 2172 of the detected CPSM 102 by calling CPSM recognizer 4500, (iii) with known CPSM ID 2172 retrieving the CPSM's 102 world radius 2173 from parameter set store 2170. Distance predictor 5900 returns the world distance 5856 of camera 101 to CPSM 102 and the world distance 5857 of CPSM 102 to the z axis of the camera's 101 intrinsic coordinate system 5854.

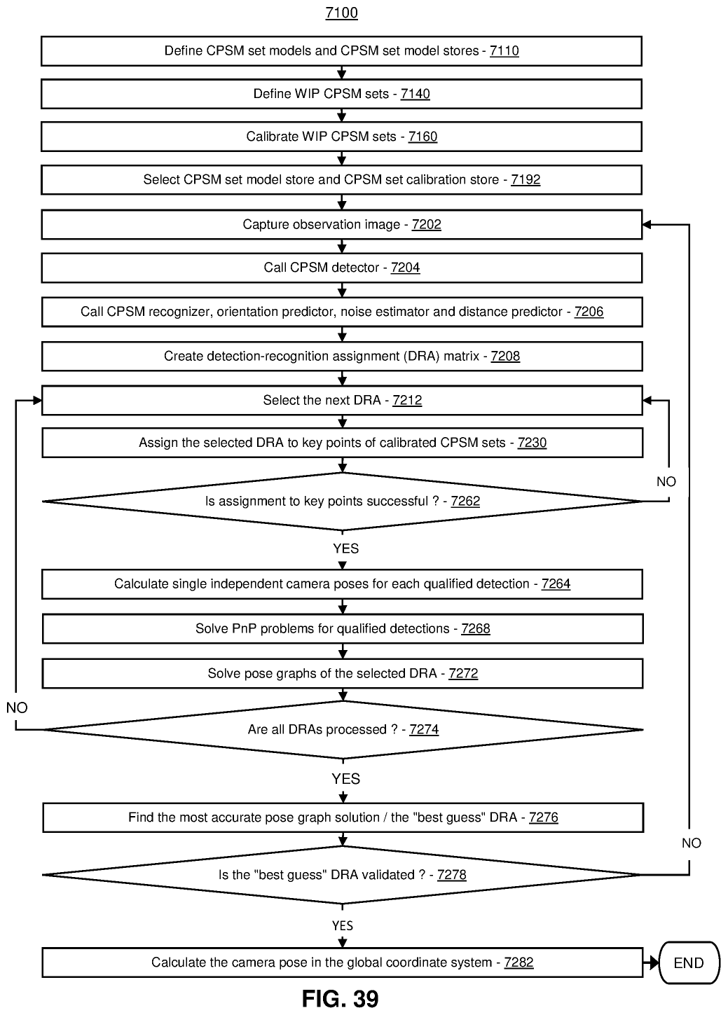

FIGS. 39 through 50 are related to CPSM set tracking controller 7100.

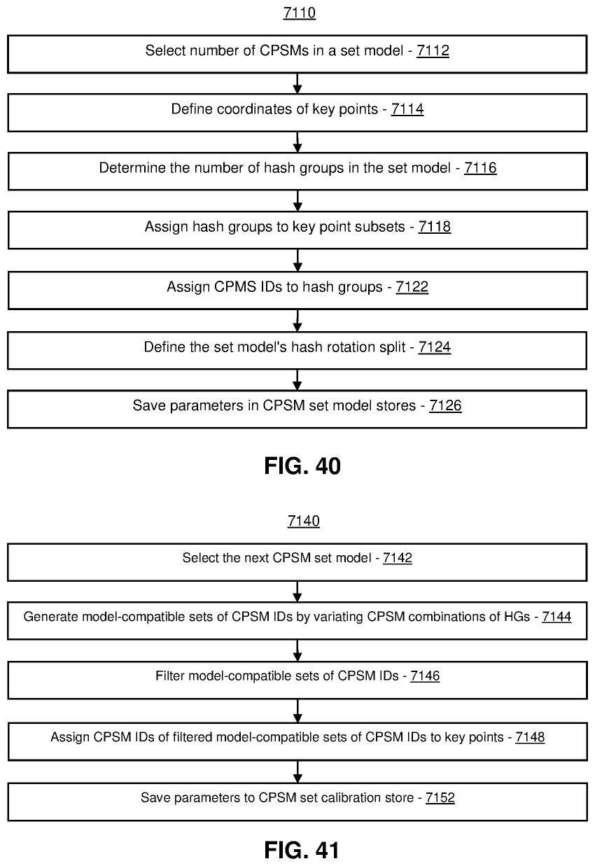

Offline subprocess 7110 is exhibited on FIGS. 40 through 44 and explains how CPSM set models 7611 and model stores 7610 are defined. Several CPSM set models 7611 may be defined and stored in a model store 7610.

In step 7112 the number of CPSMs 102 in a CPSM set model 7611 is selected. The number of CPSMs 102 in a CPSM set model 7611 is not limited. In the preferred embodiment set models 7621A through 7621F said number is ranging from 1 to 5.

In step 7114 coordinates 7614 of key points 7613 are defined. Key point 7613 with numeric position label “1” is the origin of set model's 7611 intrinsic coordinate system 7622. The x axis of intrinsic coordinate system 7622 is co-directional with the vector pointing from key point 7613 with position label “1” to key point 7613 with numeric position label “2”. The z axis of the set intrinsic coordinate system 7622 and the z axes of all set member CPSMs' 102 intrinsic coordinate systems 5833 points to key point 7613 with position label “V”. All key points' 7613 coordinates 7614 are expressed in the intrinsic coordinate system 7622. If the coordinates 7614 of key point 7613 with position label “V” is infinity (∞, ∞, ∞), it indicates that the z axes of intrinsic coordinate systems 7622 and 5833 are co-directional.

In step 7116 the number of HGs 7618 in set model 7611 is determined. Being the coordinates 7614 for a CPSM set model 7611 defined in step 7114, the length of Hash Vectors (HVs) 7623 is determined. HVs 7623 are pointing from a first key point 7613 to a second key point 7613 and are created for all possible pairs of CPSM key points 7613, excluding key point 7613 with position label “V”. HVs 7623 are identified by position labels of the first key point 7613 and the second key point 7613. The list of HVs 7623 with their respective identification index for preferred embodiment set models 7621A through 7621F are exhibited in FIG. 44. The number of HGs 7618 in a set model 7611 is determined by how many different length values HVs 7623 of set model 7611 have. For example, in the preferred embodiment set model 7621D four set-member CPSMs 102 are forming a square. HVs 7523 in a square can have two length values: (i) length of HVs 7623 HV₁₂, HV₁₄, HV₃₂ and HV₃₄, (ii) length of HVs 7623 HV₁₃ and HV₂₄. As another example, the number of HGs 7618 equals one for a regular triangle or for a regular tetrahedron variant of the preferred embodiment set models 7621C or 7621E, as all HVs 7623 in these set model 7611 variants have identical lengths.

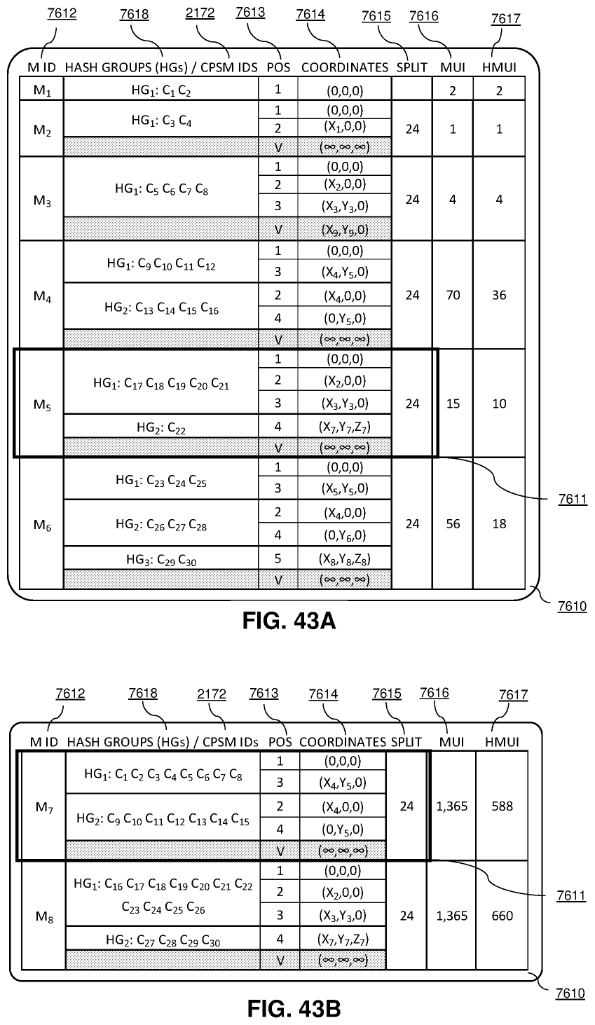

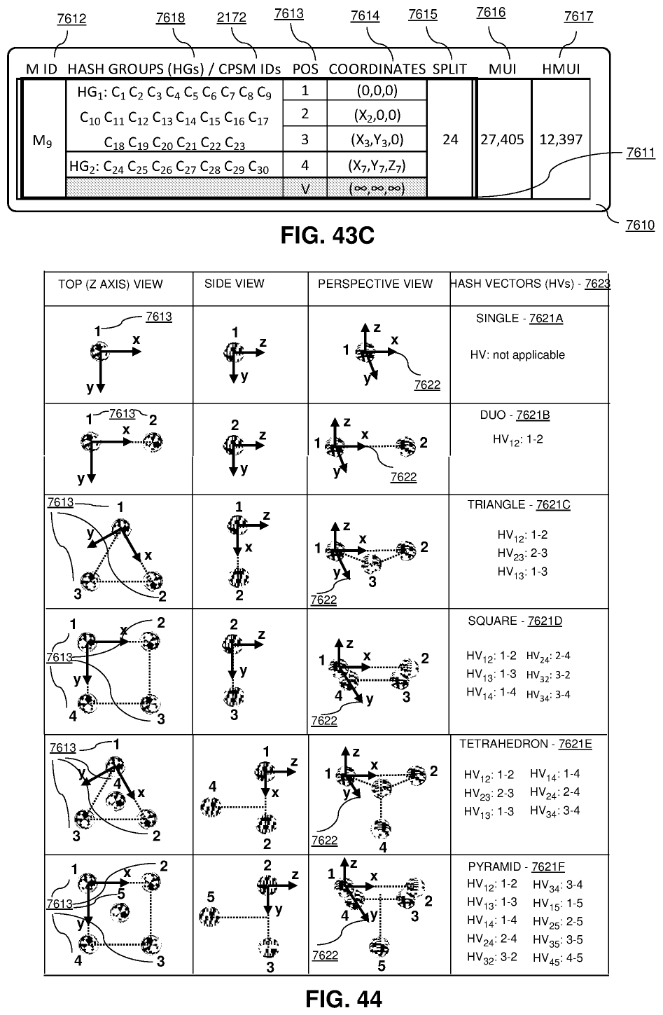

In step 7118 HGs 7618 are assigned to key point 7613 subsets in such a manner that the length of the underlying HV 7323 could be inferred by any two detected and recognized CPSMs 102 belonging to a CPSM set model 7611. Examples of HG 7618 assignments to key points 7613 subsets are exhibited in FIGS. 43A through 43C.

In step 7122 CPMS IDs 2172 are assigned to HGs 7618 of CPSM set models 7611 in such a manner that one CPSM ID 2172 can belong to only one HG 7618 of one CPSM set model 7611 in the entire set model store 7610. This restriction secures that both model ID 7612 and HG 7618 could be inferred from a detected and recognized CPSM 102. Examples of CPSM ID 2172 assignments to HGs 7618 in a CPSM set model store 7610 are exhibited in FIGS. 43A through 43C.

In step 7124 the set model's hash rotation split 7615 is defined. Hash rotation split 7615 value determines to how many sections the entire rotation space of 360 degrees is split when performing CPSM set calibrations in subprocess 7160. The higher the value of hash rotation split 7615 the more the capacity of secondary ID encoding is. It shall be understood that to take advantage of higher secondary ID encoding capacity more observation image 103 details are required, i.e., the camera 101 to CPSM 102 distance 5856 shall be lower to achieve the same secondary ID prediction accuracy. In a preferred embodiment the hash rotation split 7615 is 24.

In step 7126 parameters in CPSM set model 7611 are saved to one or more CPSM set model stores 7610, with unique model ID 7612.

The offline subprocess 7140 is exhibited in FIG. 41 and details how work-in-progress (WIP) CPSM sets 7811 are defined based on data in a CPSM set model store 7610.

In step 7142 the next CPSM set model 7611 is selected from a CPSM set model store 7610.

In step 7144 model-compatible sets of CPSM IDs are generated by variating CPSM combinations in a HG 7618 across all HGs 7618 of the CPSM set model 7611. The total number of model-compatible sets of CPSM IDs is indicated in a remark field HMUI 7617 for the example CPSM set model stores 7610, exhibited in FIGS. 43A through 43C. For reference, in a remark field MUI 7616 we see the total number of model-compatible sets of CPSM IDs, if all CPSM IDs 2172 belong to one HG 7618 of a particular CPSM set model 7611.

In step 7146 model-compatible sets of CPSM IDs generated in step 7144 are filtered, as desired by a use case where system 100 is deployed.

In step 7148 CPSMs IDs 2172 present in filtered model-compatible sets of CPSM IDs are assigned to key points 7613. The two principles of assignment are: (i) CPSM ID 2172 shall belong to the key point subset as defined by the underlying CPSM set model 7611, (ii) a CPSM ID 2172 with lower ID index shall be assigned to a key point 7613 with lower-value numeric position label.

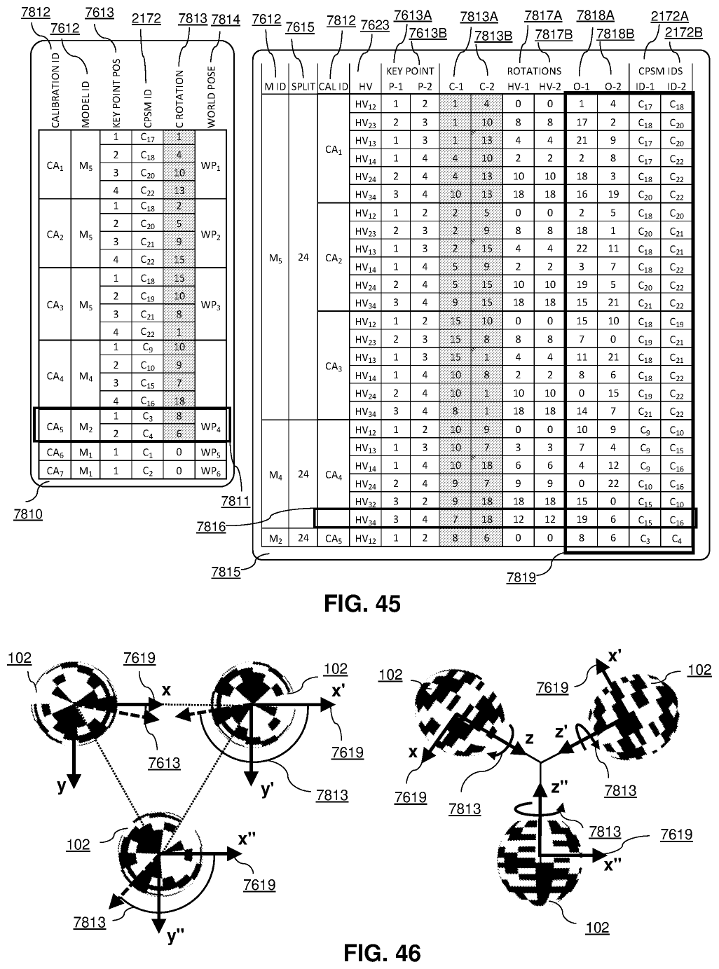

In step 7152 the end-result parameters of step 7148 are saved to CPSM set calibration store 7810 as a WIP CPSM set 7811, with unique calibration ID 7812. An example CPSM set calibration store 7810 is exhibited in FIG. 45.

The offline subprocess 7160 is exhibited in FIGS. 42, 45, 46 and describes how WIP CPSM sets 7811 of a CPSM set calibration store 7810 are calibrated.

In step 7162 the next WIP CPSM set 7811 of a CPSM set calibration store 7810 is selected.

In step 7164 the reference coordinate system 7619 to perform C rotations 7813 is determined for each key point 7613 with numeric position label. The reference coordinate system 7619 of a key point 7613 is defined by the following two constraints: (i) the z axis points to the key point 7613 with position label “V”, (ii) the x axis lies in the plane formed by the z axes of the underlying key point 7613 and the key point 7613 with the next numeric position label. If the key point 7613 with position label “V” is infinity, the reference coordinate system 7619 is the set-intrinsic coordinate system 7622, translated to the underlying key point 7613. Example reference coordinate systems 7619 are exhibited in FIG. 46.

In step 7166 C rotations 7813 are proposed for each set-member CPSM 102. The discrete C rotation 7813 values represent rotations of CPSMs 102 around the z axis of their respective reference coordinate systems 7619. One unit of C rotation 7813 corresponds to (360°/split 7615) degrees, whereas split 7615 originates from the respective CPSM set model 7611.

In step 7168 hash indices 7819 are calculated based on proposed C rotations 7813A, 7813B and the CPSM IDs 2172A, 2172B that are associated to HV's 7623 starting key point 7613A and ending key point 7613B. The HV's 7323 starting key point rotation 7817A and ending key point rotation 7817B is calculated as the quantized rotation angle necessary to achieve the co-directionality of (i) the underlying key points' 7613A, 7613B reference coordinate systems 7619 and (ii) the HV's 7323 intrinsic coordinate system. The origin of HV's 7323 intrinsic coordinate system is key point 7613A, the z axis points to key point 7613 with position label “V” and the x axis is defined by the vector pointing from key point 7613A to key point 7613B. If key point 7613 with position label “V” is infinity, the z axis is co-directional with the z axis of the CPSM set intrinsic coordinate system 7622. Observation rotations 7818A, 7818B are calculated as follows: (i) 7818A=mod(7813A−7817A,7615), (ii) 7818B=mod(7813B−7817B,7615). Hash indices 7819 are formed by concatenating observation rotations 7818A, 7818B and CMSP IDs 2172A, 2172B.

In step 7172 it is checked if hash-unique hash matrix 7815 indexing is required.

In step 7174 it is checked if all hash indices 7919 calculated in step 7118 are unique, by scanning all records 7816 of hash matrix 7815.

In step 7176 hash matrix 7815 is updated by adding hash indices 7819, calculated in step 7158.

In step 7178 it is checked if the CPSM set's calibration to a world coordinate system is required.

In step 7182 the CPSM set is calibrated by calculating world pose 7814 that transforms the CPSM set intrinsic coordinate system 7622 to a world coordinate system. To those skilled in the art techniques of calibration to a world coordinate system are well known, see an example in U.S. patent publication [5].

In step 7184 hash matrix 7815 and the parameters of calibrated CPSM set 7811, together with a unique calibration ID 7812 are saved to a CPSM set calibration store 7810.

In step 7186 it is checked if all WIP CPSM sets 7811 are processed.

In step 7192 a CPSM set model store 7610 and a CPSM set calibration store 7810 is selected. The selection is necessary to interpret observation images 103 in the right scene context and to provide a verification filter for subsequent steps 7208 through 7272. The input to determine the selections of step 7192 can be of various types, including a user manual input, a beacon signal, etc.

In step 7202 a high-resolution observation image 103 is captured by camera 101.

In step 7204 CPSM detector 3500 is called to locate all CPSMs 102 visible on the captured observation image 103. CPSM detector 3500 returns enumerated detections 7825, defined by RSBBs 3532.

In step 7206 CPSM recognizer 4500, orientation predictor 5500 and noise estimator 6500 are called by passing the following two inputs: (i) the observation image 103 and (ii) the RSBBs 3532, returned in step 7204. Distance predictor 5900 is called by passing the following inputs: (i) the coordinates of RSBBs 3532, returned in step 7204, then normalized to the observation image 103 pixel-coordinates, then converted to CPSM's 102 normalized radius 5853 and normalized radial coordinate 5855, (ii) the detected CPSMs' 102 world radii 2173, inferred from CPSM recognition results and data in parameter set store 2170. CPSM recognizer 4500 returns probabilities 7826 for CPSM IDs 2172. Recognition probability matrix 7824 is formed by concatenating CPSM IDs 2172 with their respective probability 7826 for all enumerated detections 7825.

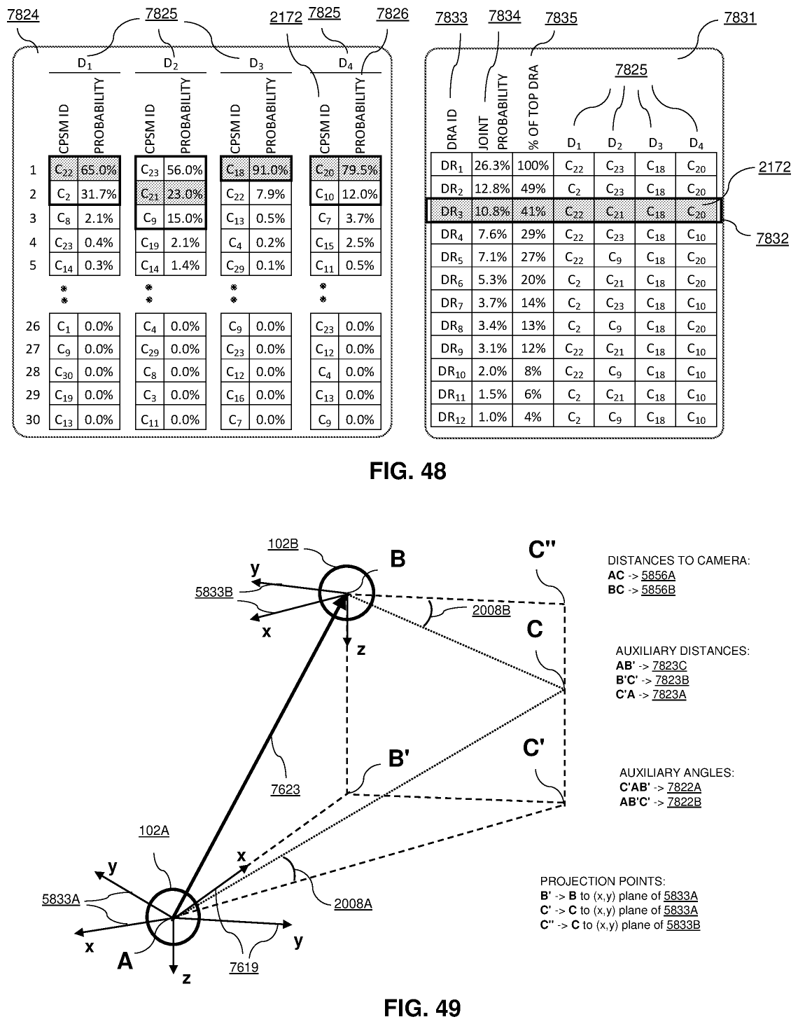

In step 7208 detection-recognition assignment (DRA) matrix 7831 is created, based on data in the recognition probability matrix 7824. DRA matrix 7831 is formed by (i) determining a probability threshold, (ii) combining CPSM IDs 102 of recognition probability matrix 7824 above the probability threshold. An example recognition probability matrix 7824 and DRA matrix 7831 with four enumerated detections 7825 and probability threshold of 10% is exhibited in FIG. 48. The twelve DRAs 7832 are sorted in DRA matrix 7831 by joint probability 7834 and identified by DRA ID 7833. The trivial DRA 7832 is the one with the highest joint probability 7834. However, CPSM recognizer 4500 may not return the ground truth CPSM ID 2172 of an enumerated detection 7825 with the highest probability 7826, attributable to various noise artifacts. Therefore, all DRAs 7832 in a DRA matrix 7831 are checked and validated with geometric constraints, stored in the selected CPSM set model store 7610 and the selected CPSM set calibration store 7810. Enumerated detections 7825 with inconsistent and/or conflicting CPSM ID 2172 in a DRA 7832 are ignored in camera pose estimation steps 7264 through 7272.

In step 7212 the next DRA 7812 is selected.

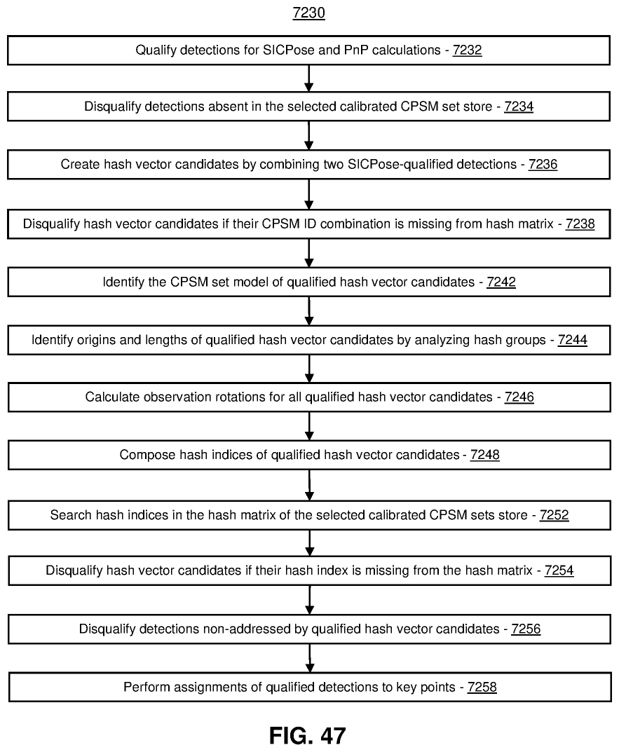

Subprocess 7230 is exhibited in FIG. 47 and describes the steps of how the DRA 7832, selected in step 7212 is assigned to key points 7613 of calibrated CPSM sets 7811 of the selected CPSM set calibration store 7810. To better understand subprocess 7230 DRAs 7832 exhibited in FIG. 48 will be analyzed with the assumption that the selected CPSM set calibration store 7810 and the associated hash matrix 7815 are the ones exhibited in FIG. 45.

In step 7232 enumerated detections 7825 are qualified or disqualified (i) for Single Independent Camera Pose (SICPose) calculations and (ii) for PnP calculations, depending on the enumerated detections' 7825 RSBB 3532 size and noise score. In a preferred embodiment an enumerated detection's 7825 RSBB 3532 must reach (i) 50×50 pixels to qualify for SICPose and (ii) 20×20 pixels to qualify for PnP calculations. Noise scores are estimated by noise estimator 6500 in step 7206. It is noted here that—because of the RSBB 3532 minimum size qualification criteria—camera pose calculations purely based on PnP problem solutions can be performed at significantly larger camera 101 to CPSM 102 distances than SICPose calculations.

In step 7234 enumerated detections 7825 with CPMSs ID 2172 absent in the selected calibrated CPSM set store 7810 are disqualified. As an example, enumerated detections 7825 with label D₂ of DRAs 7832 with DRA IDs 7833 DR₁,DR₂,DR₄ and DR₇ are disqualified, as CPSM ID 2172 C₂₃ is not present in the selected calibrated CPSM set store 7810.

In step 7236 HV 7623 candidates are created by combining two SICPose-qualified enumerated detections 7825. For example, DRA 7832 with DRA IDs 7833 DR₁ and DR₂ have three HV 7623 candidates: (i) {D₁,D₃}, (ii) {D₁,D₄}, (iii) {D₃,D₄}, as D₂ was disqualified in step 7234. DRA 7832 with DRA ID 7833 DR₃ has six HV 7623 candidates: (i) {D₁,D₂}, (ii) {D₁,D₃}, (iii) {D₁,D₄}, (iv) {D₂,D₃}, (v) {D₂,D₄}, (vi) {D₃,D₄}.

In step 7238 HV 7623 candidates are disqualified if their CPSM ID 2172 combination is missing from hash matrix 7815. For example, two out of three HV 7623 candidates of DRA 7832 with DR ID 7833 DR₂ are disqualified: (i) {D₁, D₃} and (ii) {D₁, D₄}, as CPSM ID 2172 combinations {C₂, C₁₈} and {C₂, C₂₀} are missing from hash matrix 7815.

In step 7242 the CPSM set model 7611 of qualified HV 7623 candidates are identified. The CPSM set model 7611 identification is inferred from the CPSM IDs 2172 of the HV 7623 candidates, as CPSM set model stores 7610 are defined in offline subprocess 7110 with a constraint that there should be no overlap of CPSM IDs 2172 between different CPSM set models 7611. As an example, all qualified HV 7623 candidates of DRAs 7832 with DRA IDs 7833 DR₁ through DR₉ and DR₁₁ belong to tetrahedron 7621E CPSM set model 7611 with model ID 7612 M₅. DRA 7832 with DRA ID 7833 DR₁₀ has two qualified HV 7623 candidates: (i) {D₁,D₃} belonging to tetrahedron 7621E CPSM set model 7611 with model ID 7612 M₅ and (ii) {D₂,D₄} belonging to square 7621D CPSM set model 7611 with model ID 7612 M₄.

In step 7244 the origins and lengths of qualified HV 7623 candidates are identified by analyzing (i) the HGs 7618 and coordinates 7614 of the underlying CPSM set models 7611 and (ii) the CPSM ID 2172 indices. For example, the origins and lengths of two qualified HV 7623 candidates of DRA 7832 with DRA ID 7833 DR₁: (i) {D₁, D₃}'s origin=D₃, length=sqrt(X₇²+Y₇²+Z₇²), as the CPSM ID 2172 of D₁ belongs to HG 7618 HG₂ and the CPSM ID 2172 of D₃ belongs to HG 7618 HG₁, (ii) {D₃, D₄}'s origin=D₃, length=X₂, as both D₃ and D₄ belong to the same HG 7618 HG₁ and the CPSM ID 2172 index of D₃ is lower than the CPSM ID 2172 index of D₄.

In step 7246 observation rotations 7818 are calculated for all qualified HV 7623 candidates using: (i) the elevation angle 2008 and azimuthal angle 2007 output of orientation predictor 5500, called in step 7206, (ii) the output of distance predictor 5900, called in step 7206, (iii) the geometric properties of the HV 7623 candidates within their underlying CPSM set models 7611. The sequence of calculations is better understood from an example exhibited in FIG. 49: (i) the HV 7623 candidate is {D₁, D₃}, originated from DRA 7832 with DRA ID 7833 DR₃, {D₁,D₃} hypothetically is part of a tetrahedron set 7621E with model ID 7612 M₅; (ii) it is inferred from the CPSM IDs 2172 of {D₁, D₃} that CPSM 102A corresponds to enumerated detection 7825 D₃ and CPSM 102B to enumerated detection 7825 D₁; (iii) distance 7823C is calculated from coordinates 7614 of CPSM set model 7611 with model ID 7612 M₅; (iv) distances 7823A=cos(2008A)*5856A and 7823B=cos(2008B)*5856B, where 2008A,2008B are the elevation angle predictions of orientation predictor 5500, called in step 7206, and 5856A,5856B are outputs of distance predictor 5900 called in step 7206; (v) angles 7822A,7822B are calculated from the triangle formed by 7823A,7823B,7823C; (vi) observation rotations 7818A=2007A−7822A and 7818B=2007B−7822B, where 2007A,2007B are the azimuthal angle predictions of orientation predictor 5500, called in step 7206. Elevation angles 2008A,2008B and azimuthal angles 2007A,2007B refer to CPSM intrinsic coordinate systems 5833A,5833B, respectivelly.

In step 7248 hash indices 7819 are composed by concatenating (i) the two quantized observation rotations 7818, divided by split 7615 and (ii) the two ordered CPSM IDs 2172 of the qualified HV 7623 candidates.

In step 7252 hash indices 7819, composed in step 7248 are searched in the hash matrix 7815 of the selected calibrated CPSM sets store 7810.

In step 7254 HV 7623 candidates may be disqualified if their hash index 7819 is missing from the underlying hash matrix 7815.

In step 7256 SICPose-qualified enumerated detections 7825, non-addressed by a qualified HV 7623 candidate may be SICPose disqualified.

In step 7258 assignments of SICPose and/or PnP qualified enumerated detections 7825 to key points 7613 of calibrated CPSM sets 7811 are performed. The assignment may be ambiguous, in which case plurality of key point assignments scenarios are created.

In step 7262 control is passed to step 7212 if there are no qualified enumerated detections 7825 left.

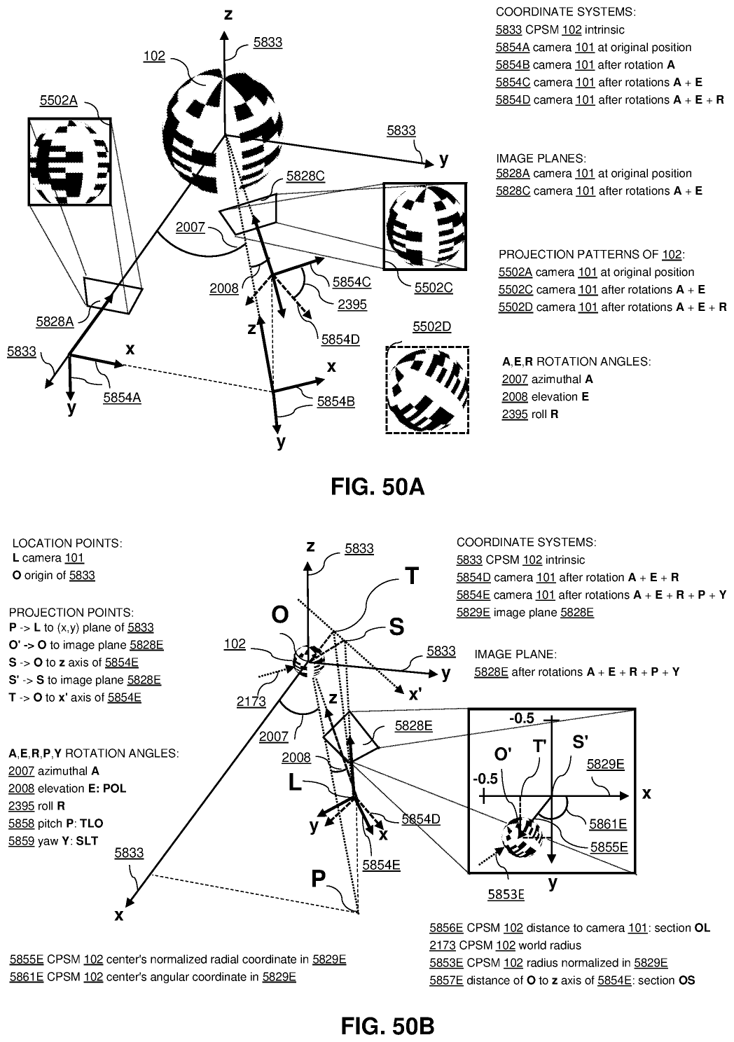

In step 7264 SICPoses are estimated for each SICPose-qualified enumerated detection 7825. FIGS. 50A and 50B disclose the steps of SICPose estimation in detail. Image plains 5828 are imitating observation images 103 at various camera 101 poses. The intrinsic 2D coordinate systems 5829 of image plains 5828 are normalized by converting the pixel-coordinates of the imitated observation images 103 to range {−0,5 . . . 0,5}. Projection patterns 5502 are image crops from image planes 5828 defined by RSBBs 3532. Projection patterns 5502 are used as inputs to orientation predictor 5500. Outputs of orientation predictor 5500 are (i) azimuthal angle 2007 of A rotation, (ii) elevation angle 2008 of E rotation and (iii) roll angle 2395 of R rotation, (iv) APR angle and (v) AMR angle. Rotation A rotates the CPSM's 102 intrinsic coordinate system 5833 around its z axis by azimuthal angle 2007 and then rotation E rotates coordinate system 5833 around its new y axis by elevation angle 2008. Rotation R rotates the camera 101 intrinsic coordinate system 5854C around its z axis by roll angle 2395, as exhibited in FIG. 50A. APR angle and AMR angle may be used to handle singularity scenarios, i.e. when the predicted elevation angle 2008 indicates that CPSM 102 is viewed from or about the south or north pole directions, and—as a consequence of the training methodology of orientation trainer 5300—both the azimuthal angle 2007 and the roll angle 2395 predictions of orientation predictor 5500 are inaccurate. FIG. 50B exhibits a pose scenario of camera 101. Distances 5856E and 5857E are output distances of distance predictor 5900, called in step 7208 with inputs (i) CPSM 102 world radius 2173, (ii) CPSM 102 normalized radius 5853E, (iii) CPSM 102 normalized radial coordinate 5855E. The location of camera 101 in coordinate system 5833 is estimated by its spherical coordinates, azimuthal angle 2007 being θ (theta), elevation angle 2008 being ϕ (phi) and—the distance of camera 5856E from origin of coordinate system 5833—being ρ (rho). Angle 5858 of pitch rotation P and angle 5859 of yaw rotation Y are estimated as follows:

5858=arc sin(5857E/5856E*sin(5861E)), (i)

5859=arc sin(5857E/5856E*cos(5861E)) (ii)

where 5861E is the angular coordinate of CPSM 102 in image plane coordinate system 5829E. Having the rotations' A,E,R,P,Y angle values estimated from image plane 5828E observations, camera 101 orientation in CPSM 102 intrinsic coordinate system 5833 is calculated as a sequence of the following five rotations: (i) azimuthal A by angle 2007 around the y axis of coordinate system 5854A, (ii) elevation E by angle 2008 around the x axis of coordinate system 5854B, (iii) roll R by roll angle 2395 around z axis of coordinate system 5854D, (iv) pitch P by angle 5858 around of x of coordinate system 5854D, (v) yaw Y by angle 5859 around of y of coordinate system 5854D.

In step 7268 PnP problems are solved for all subsets of PnP-qualified enumerated detections 7825 that are (i) assigned in subprocess 7230 to key points 7613 of one calibrated set 7811, (ii) the plurality of PnP-qualified enumerated detections 7825 in the said subset is four or more. The centers of RSBBs 3532 act as 2D points that correspond to 3D points, determined by (i) the assignment to key points 7613 of a calibrated CPSM set 7811 and (ii) the coordinates of key points 7313, retrieved from a CPSM set model 7611 with identical model ID 7612. Solving PnP problems is well known to those skilled in the art. The solutions to PnP problems are camera 101 pose estimates in the intrinsic coordinate systems 7622 of calibrated CPSM sets 7811.

In step 7272 pose graphs are solved for the selected DRA 7832 for all key point assignments scenarios. The pose graphs comprise nodes for (i) the SICPoses estimated in step 7264, (ii) the PnP pose estimates, calculated in step 7268, (iii) the constraints between SICPoses and PnP pose estimates, defined by geometric relationships of key points 7313 in CPSM set models 7611, (iv) the constraints of calibrated CPSM sets 7811, registered as landmarks with their known world poses 7814. Formulating and solving pose graphs are well known to those skilled in the art and described in detail, for example in U.S. patent publication [5].

In step 7274 it is checked if all DRAs 7832 are processed.

In step 7276—having solved the pose graphs for all DRAs 7832 and for all key point assignments scenarios in steps 7212 through 7272—the most accurate pose graph solution is searched for, attached to one “best guess” DRA 7832 with one “best guess” key point assignment scenario. The semantic and geometric constraint filters applied in subprocess 7230 are independent from the visual information extracted from observation image 103 and aim to compensate noise and the detection and/or recognition inaccuracies of CPSM detector 3500 and CPSM recognizer 4500. Enumerated detections 7825 in a DRA 7832 may be disqualified if they are not consistent with semantic and/or geometric constraints, therefore the primary accuracy metric of a pose graph solution is the number of qualified enumerated detections 7825, applied in step 7272. The secondary accuracy metric is the distance variation of SICPose locations relative to the location of the pose graph solution of a DRA 7832 with a selected key point assignment scenario. The secondary accuracy metric is applied if DRAs 7832 with the same number of qualified enumerated detections 7825 are competing, in which case the DRA 7832 and the key point assignment scenario with the lowest distance variation is winning the status of “best guess” DRA 7832. It is noted here that the search for the “best guess” DRA 7832 and the “best guess” key point assignment scenario may include temporal and pose consistency checks with previous observation image 103 measurements.

In step 7278 the final validation of the “best guess” DRA is performed. If the “best guess” DRA's 7832 joint probabilities as percent of top DRA 7835 is below of an a-priori defined threshold, the “best guess” DRA 7832 may be disqualified. Step 7278 anticipates observation image 103 scenarios where “non-registered” CPSMs 102 show up in the scene, which may disturb the semantic and/or geometric constraint filters, applied in subprocess 7230.

In step 7282 the camera pose in the global coordinate system is calculated. Successful calculation of camera pose in global coordinate system is subject to detection of CPSMs 102 that are members of a calibrated CPSM set 7811 and are registered as landmark by world pose 7814. If calculation of camera pose in global coordinate system is successful, inferred world poses 7814 of other calibrated CPSM sets 7811 are back written to CPSMS set calibration store 7810 to serve further as registered landmarks.

1. A fiducial marker suited to be sensed by a camera, comprising
a. a substantially spheroid surface; and
b. a spheroidal grid, wherein the spheroidal grid confines a plurality of cells, wherein each cell has one color.

2. The fiducial marker of claim 1, wherein the spheroidal grid consists of longitudinal and latitudinal spheroidal lines.

3. The fiducial marker of claim 2, wherein the areas of the cells are substantially equal.

4. The fiducial marker of claim 2, wherein the longitudinal spheroidal lines or the latitudinal spheroidal lines are modulated.

5. A method for forming a fiducial marker comprising a substantially spheroid surface and a spheroidal grid, wherein the spheroidal grid confines a plurality of cells, wherein each cell has one color, the method comprising:
a. defining, a first plurality of colors, wherein the colors are dark;
b. defining, a second plurality of colors, wherein the colors are light;
c. defining, color modulation frequencies for dark colors and lights colors;
d. generating, a binary cell polarity matrix, wherein the number of matrix elements equals the number of cells; and
e. assigning colors, to each element of the plurality of cells, from the first plurality of colors or from the second plurality of colors, based on the color modulation frequencies and the binary cell polarity matrix, wherein the binary cell polarity matrix determines the color being assigned from the first plurality of colors or the second plurality of colors, and the color modulation frequencies determine the occurrence rate of colors.

6. The method of claim 5, wherein the binary cell polarity matrix is generated by cropping a Hadamard matrix.

7. The method of claim 5, wherein the binary cell polarity matrix is generated from a binary seed pattern array, wherein the generation comprising the steps of:
a. circularly shifting the replicated binary seed pattern array, to form an initial pattern matrix; and
b. modulating the initial pattern matrix.

8. A method for covering three-dimensional space, for purpose of 6 degree-of-freedom positioning, with fiducial markers comprising a substantially spheroid surface and a spheroidal grid, wherein the spheroidal grid confines a plurality of cells, wherein each cell has one color, the method comprising:
a. designing, a plurality of fiducial markers, wherein each fiducial marker has a marker identifier;
b. arranging, the plurality of fiducial markers in the three-dimensional space;
c. defining, plurality of sets, by grouping the elements of the plurality of fiducial markers, wherein each set comprises at least one fiducial marker;
d. encoding, set primary identifiers, for at least one set of the plurality of sets; and
e. determining, three-dimensional locations, of at least one element of at least one of the sets, relative to at least one reference coordinate system.

9. The method of claim 8, wherein the marker identifiers of the elements of the sets are different within each set.

10. The method of 8, the method further comprising:
a. determining, orientations, of at least one element of at least one of the sets, relative to at least one reference coordinate system.

11. The method of claim 10, the method further comprising:
a. encoding, set secondary identifiers, for at least one set of the plurality of sets.

12. The method of claim 11, the method further comprising:
a. arranging, the plurality of fiducial markers, in the three-dimensional space, in a manner that the encoded set secondary identifiers combined with the encoded set primary identifiers are unique.

13. The method of claim 11, the method further comprising:
a. arranging, the plurality of fiducial markers, in the three-dimensional space, in a manner that the encoded set secondary identifiers combined with the encoded set primary identifiers are unique, wherein the encoding of the set primary identifiers and the encoding of the set secondary identifiers ignore any one or more elements of the sets.

14. A system determining pose of a camera, the system comprising:
a. one or more cameras;
b. a first plurality of fiducial markers arranged in a three-dimensional space, wherein the fiducial markers comprising a substantially spheroid surface and a spheroidal grid, wherein the spheroidal grid confines a plurality of cells, wherein each cell has one color;
c. a hardware computer processor;
d. a non-transitory computer readable medium having software instructions stored thereon, the software instructions executable by the hardware computer processor to cause the system to perform operations comprising:
i. rendering synthetic images, based on the first plurality of fiducial markers;
ii. generating training samples, from the rendered synthetic images;
iii. training a detector and a recognizer, based on the generated training samples;
iv. accessing, from at least one camera, an image including a second plurality of fiducial markers on a substrate;
v. determining two-dimensional locations, for at least one element of the second plurality of fiducial markers in the image, by applying the trained detector;
vi. determining marker identifiers, for at least one element of the second plurality of fiducial markers in the image, by applying the trained recognizer; and
vii. determining pose of the camera, based at least on the determined two-dimensional locations and the determined marker identifiers.

15. The system of claim 14, wherein the pose of the camera is further determined based on application of a perspective-n-point algorithm.

16. The system of claim 14, wherein the system further comprise:
a. a set tracking controller database, storing at least encoded set primary identifiers and three-dimensional locations of at least one element of the sets, relative to the at least one reference coordinate system.

17. The system of claim 16, wherein the pose of the camera is further determined based on application of a perspective-n-point algorithm and analyzing the encoded set primary identifiers and the three-dimensional locations, stored in the set tracking controller database.

18. The system of claim 14, wherein the operations further comprise:
a. training an orientation predictor, based on the generated training samples; and
b. determining marker orientations, for at least one element of the second plurality of the fiducial markers in the image, by applying the trained orientation predictor.

19. The system of claim 18, wherein the system further comprise:
a. a set tracking controller database, storing at least encoded set primary identifiers, encoded set secondary identifiers and three-dimensional locations of at least one element of the sets, relative to the at least one reference coordinate system.

20. The system of claim 19, wherein the pose of the camera is further determined based on application of a perspective-n-point algorithm and analyzing the encoded set primary identifiers, the encoded set secondary identifiers and the three-dimensional locations stored in the set tracking controller database.

21. The system of claim 18, wherein the operations further comprise:
a. training a distance predictor;
b. determining marker distances, based at least on the two-dimensional locations, by applying the trained distance predictor; and
c. determining marker poses, based at least on the determined marker orientations and the determined marker distances.

22. The system of claim 21, wherein the pose of the camera is further determined based at least on the determined marker poses.
